(19) United States
(12) Patent Application Publication
(10) Pub. No.: US 2025/0237853 A1
(43) Pub. Date: Jul. 24, 2025

(54) OPTICAL SYSTEM, IMAGE PICKUP APPARATUS, AND PROJECTION APPARATUS

(71) Applicant: CANON KABUSHIKI KAISHA, Tokyo (JP)

(72) Inventor: Daisuke ITO, Tochigi (JP)

(21) Appl. No.: 18/980,173

(22) Filed: Dec. 13, 2024

(30) Foreign Application Priority Data
Jan. 23, 2024 (JP) 2024-007715

(51) Int. Cl. G02B 13/00; G02B 9/12

(52) U.S. Cl. CPC G02B 13/006; G02B 9/12; G02B 13/0035; G02B 13/0065

(57) ABSTRACT

An optical system includes a fully opened diaphragm, and a first transmissive reflective surface, a quarter waveplate, and a second transmissive reflective surface, which are arranged in this order from an enlargement side to a reduction side. Light from the enlargement side transmits through the first transmissive reflective surface and the quarter waveplate in this order, is reflected by the second transmissive reflective surface to the enlargement side, transmits through the quarter waveplate, is reflected by the first transmissive reflective surface to the reduction side, and transmits through the quarter waveplate and the second transmissive reflective surface in this order toward the reduction side. Each of the first transmissive reflective surface and the second transmissive reflective surface has a convex surface facing the enlargement side. A predetermined inequality is satisfied.

### BACKGROUND

### Technical Field

The present disclosure relates to an optical system, an image pickup apparatus, and a projection apparatus.

### Description of Related Art

An optical system has conventionally been known that uses a reflective surface to control an incident angle of a light ray in front of an imaging point. Japanese Patent Laid-Open No. 2009-80411 discloses an optical system utilizing surface reflections within the lenses. Japanese Patent No. 6567047 discloses a configuration of an eyepiece lens for a head mount display.

### SUMMARY

An optical system according to one aspect of the disclosure includes, in order from an enlargement side to a reduction side, a first transmissive reflective surface, a quarter waveplate, and a second transmissive reflective surface. Light from the enlargement side transmits through the first transmissive reflective surface and the quarter waveplate in this order, is reflected by the second transmissive reflective surface toward an enlargement side, transmits through the quarter waveplate, is reflected by the first transmissive reflective surface toward the reduction side, and transmits through the quarter waveplate and the second transmissive reflective surface in this order toward the reduction side. Each of the first transmissive reflective surface and the second transmissive reflective surface has a convex surface facing the enlargement side. The optical system further includes a first lens that has a lens surface different from the first transmissive reflective surface and the second transmissive reflective surface, and a second lens arranged on the reduction side of the first lens. One of the first lens and the second lens has negative refractive power and is disposed adjacent to and on the enlargement side the first transmissive reflective surface.

An optical system according to another aspect of the disclosure includes a fully opened diaphragm, and a first transmissive reflective surface, a quarter waveplate, and a second transmissive reflective surface, which are arranged in this order from an enlargement side to a reduction side. Light from the enlargement side transmits through the first transmissive reflective surface and the quarter waveplate in this order, is reflected by the second transmissive reflective surface to the enlargement side, transmits through the quarter waveplate, is reflected by the first transmissive reflective surface to the reduction side, and transmits through the quarter waveplate and the second transmissive reflective surface in this order toward the reduction side. Each of the first transmissive reflective surface and the second transmissive reflective surface has a convex surface facing the enlargement side. The following inequality is satisfied:

0.00≤Ls/L≤1.00

where L is a distance on an optical axis from an enlargement-side surface of a lens closest to the enlargement side of the optical system to a panel plane, and Ls is a distance on an optical axis from the fully opened diaphragm to the first transmissive reflective surface.

Further features of various embodiments of the disclosure will become apparent from the following description of embodiments with reference to the attached drawings.

### BRIEF DESCRIPTION OF THE DRAWINGS

FIG. 1 is a schematic diagram illustrating an optical path of an optical system according to each example.

FIG. 2 is a schematic diagram illustrating an optical path of the optical system according to each example.

FIG. 3 is a schematic diagram illustrating an optical path of the optical system according to each example.

FIG. 4 is a sectional view of the optical system in an in-focus state at infinity in Example 1.

FIG. 5 is an aberration diagram of the optical system in an in-focus state at infinity in Example 1.

FIG. 6 is a sectional view of an optical system in an in-focus state at infinity in Example 2.

FIG. 7 is an aberration diagram of the optical system in an in-focus state at infinity in Example 2.

FIG. 8 is a sectional view of an optical system in an in-focus state at infinity in Example 3.

FIG. 9 is an aberration diagram of the optical system in an in-focus state at infinity in Example 3.

FIG. 10 is a sectional view of an optical system in an in-focus state at infinity in Example 4.

FIG. 11 is an aberration diagram of the optical system in an in-focus state at infinity in Example 4.

FIG. 12 is a sectional view of an optical system in an in-focus state at infinity in Example 5.

FIG. 13 is an aberration diagram of the optical system in an in-focus state at infinity in Example 5.

FIG. 14 is a sectional view of an optical system in an in-focus state at infinity in Example 6.

FIG. 15 is an aberration diagram of the optical system in an in-focus state at infinity in Example 6.

FIG. 16 is a sectional view of an optical system in an in-focus state at infinity in Example 7.

FIG. 17 is an aberration diagram of the optical system in an in-focus state at infinity in Example 7.

FIG. 18 is a sectional view of the optical system in an in-focus state at infinity in Example 8.

FIG. 19 is an aberration diagram of the optical system in an in-focus state at infinity in Example 8.

FIG. 20 is a sectional view of an optical system in an in-focus state at infinity in Example 9.

FIG. 21 is an aberration diagram of the optical system in an in-focus state at infinity in Example 9.

FIG. 22 is a sectional view of an optical system in an in-focus state at infinity in Example 10.

FIG. 23 is an aberration diagram of the optical system in an in-focus state at infinity in Example 10.

FIG. 24 is a sectional view of an optical system in an in-focus state at infinity in Example 11.

FIG. 25 is an aberration diagram of the optical system in an in-focus state at infinity in Example 11.

FIG. 26 is a sectional view of an optical system in an in-focus state at infinity in Example 12.

FIG. 27 is an aberration diagram of the optical system in an in-focus state at infinity in Example 12.

FIG. 28 is a sectional view of an optical system in an in-focus state at infinity in Example 13.

FIG. 29 is an aberration diagram of the optical system in an in-focus state at infinity in Example 13.

FIG. 30 is a schematic diagram of an image pickup apparatus having the optical system according to any one of the above examples.

FIG. 31 is a schematic diagram of a projection apparatus having the optical system according to any one of the above examples.

### DETAILED DESCRIPTION

Referring now to the accompanying drawings, a detailed description will be given of examples according to the disclosure. Corresponding elements in respective figures will be designated by the same reference numerals, and a duplicate description thereof will be omitted.

An imaging optical system according to each example is an optical system configured to form an object image on an image plane, and acquire an image by a solid-state image sensor or a photosensitive film disposed on an image plane. This imaging optical system can also be used as a projection optical system configured to project an image toward an object with an imaging point as a light emitting surface.

The imaging optical system according to each example can be used as an image pickup apparatus such as a smartphone imaging camera, a distance detecting camera, a lens fixed type camera, or a disposable film camera, which has an image sensor that receives an image formed by the imaging optical system. The imaging optical system according to each example can also be used as an interchangeable lens of a video camera, a digital still camera, or an interchangeable lens camera. It can also be used as a projection lens for a projection system having a light emitting panel.

The imaging optical system according to each example may be used in a camera viewfinder or an XR device, for example, for line-of-sight (visual line) detection, biometric recognition, or facial expression recognition. It may also be used for external world recognition applications such as XR devices and automatic robots. It can also be used as a projection optical system in an AR glass.

The imaging optical system according to each example includes, in order from the enlargement side to the reduction side, a first transmissive reflective surface, a quarter waveplate QWP, and a second transmissive reflective surface. Light from the enlargement side transmits through the first transmissive reflective surface and then the quarter waveplate QWP, and is reflected by the second transmissive reflective surface. The light then transmits through the quarter waveplate QWP, is reflected by the first transmissive reflective surface, transmits through the quarter waveplate QWP, and the second transmissive reflective surface, and heads toward an imaging unit such as a solid-state image sensor or photosensitive film. In a case where this imaging optical system is a projection optical system, light rays are emitted from the image sensor as a light emitting panel, through the route in reverse to that of the imaging optical system, and are projected onto the enlargement side.

The first and second transmissive reflective surfaces do not necessarily have a transmittance of 50% and a reflectance of 50%. A ratio of the transmittance to the reflectance for randomly polarized light may be in a range of 1:3 to 3:1. Randomly polarized light is light with Stokes parameters S0=1, S1=S2=S3=0. The first and second transmissive reflective surfaces may absorb light. Lenses may be formed or bonded to both sides or one side of each transmissive reflective surface.

The quarter waveplate QWP may use, for example, a polymer film, or liquid crystal alignment layer having birefringence. A stack of such polymer films or liquid crystal alignment layers may also be used as the QWP. Properly stacking them can provide a phase difference close to a quarter of the wavelength in a wide wavelength range. The quarter waveplate QWP may be, for example, an inorganic waveplate from Dexerials Corporation.

The quarter waveplate QWP may be cemented, for example, with the first or second transmissive reflective surface. The quarter waveplate QWP may also be disposed separately from these transmissive reflective surfaces. For example, the film as the quarter waveplate QWP may be inserted directly into the optical path, or the film may be bonded to a glass plate and inserted into the optical path. A lens may be formed or cemented on both sides or one side of the quarter waveplate QWP. For example, a lens may be molded on one side or both sides of the inorganic waveplate using wafer-level optics technology as a substrate.

The characteristic configuration of the optical system according to each example will now be described.

The first or second transmissive reflective surface in the optical system according to each example may be convex on the enlargement side. An off-axis light ray traveling from the enlargement side to the reduction side is reflected by the second transmissive reflective surface after passing through the first reflective surface, is reflected again by the first transmissive reflective surface, and transmits through the second transmissive reflective surface to become a telecentric light ray.

After the light is reflected by the first and second transmissive reflective surfaces, the light transmits through the second transmissive reflective surface and becomes telecentric, and a point at which the light transmits through the second transmissive reflective surface and an imaging position are located approximately at the same position perpendicular to the optical axis. In other words, the light moves by reflection and by a distance in a direction perpendicular to the optical axis from a point at which the light transmits through the first transmissive reflective surface to a point at which the light transmits through the second transmissive reflective surface.

The first and second transmissive reflective surfaces that are convex on the enlargement side enable the light to move in the direction perpendicular to the optical axis from the transmission point of the first transmissive reflective surface to the transmission point of the second transmissive reflective surface. Thus, the point at which the light transmits through the second transmissive reflective surface and the imaging position can be located approximately at the same position perpendicular to the optical axis. In other words, the light beam can be telecentric.

Since the light ray transmits through the first transmissive reflective surface, is reflected by the second transmissive reflective surface, and returns to the first transmissive reflective surface, an optical path between them reciprocates to show a light ray folding effect. The length of the light ray that is originally required is folded, and the overall lens length can be reduced.

The first and second transmissive reflective surfaces that are convex on the enlargement side can significantly adjust a distance from the transmission point of the first transmissive reflective surface to the transmission point of the second transmissive reflective surface in the direction perpendicular to the optical axis. For example, even if the transmission point of the first transmissive reflective surface of the most off-axis light ray passing through the optical system passes near the optical axis, adjusting the convex shapes on the enlargement side of the first and second transmissive reflective surfaces can set the transmission position of the second transmissive reflective surface so that the light transmits through the same position as the outermost peripheral position of the image sensor. If the transmission point of the first transmissive reflective surface could be set near the optical axis, a lens diameter of the object could be smaller than that of the first transmissive reflective surface, and the size reduction can be achieved.

The reflections of the first and second transmissive reflective surfaces have the effect of adjusting the positions of the transmission points of the first and second transmissive reflective surfaces in the direction perpendicular to the optical axis. Nevertheless, even if a lens system has only this surface, the optical system cannot satisfy the optical performance for a large diameter and thick light beam. The optical system according to each example may include at least two lenses (a first lens and a plurality of lenses including a second lens disposed on the reduction side of the first lens) that include lens surfaces different from the first and second transmissive reflective surfaces. This configuration can secure good optical performance by effectively correcting aberration. Since the first and second transmissive reflective surfaces have a reflective structure, no chromatic aberration occurs, and the refractive power and Petzval sum can be manipulated, so if there are two refractive power lenses in addition to the reflective surfaces, high performance can be achieved with a small number of lenses and a large aperture diameter.

A description will now be given of the configuration that may be satisfied in the optical system according to each example.

One of the first transmissive reflective surface and the second transmissive reflective surface may be a surface that separates the incident light into reflected light and transmitting light according to the polarization state. More specifically, as described later, a polarization-selective transmissive reflective element may be used as one of the first transmissive reflective surface and the second transmissive reflective surface. Examples of the polarization-selective transmissive reflective element include a product name “WGF” manufactured by Asahi Kasei Corporation and a product name “IQPE” manufactured by 3M Company. An optical element that is created by forming a grid on the lens reflection surface during lens molding and evaporating, printing, or lithography a metal or dielectric on the grid may be used as the polarization-selective transmissive reflective element. A half-mirror, a cholesteric liquid crystal, a holographic optical element, or the like can be used as the other. In a case where a half-mirror is used, a randomly polarized light amount incident from the enlargement side becomes 12.5% or less by the time it reaches the image plane. By using cholesteric liquid crystals or holographic optical elements, a light amount on the image plane can be significantly increased, approximately doubled, compared to when a half-mirror is used.

At least one of the lenses disposed separately from the first transmissive reflective surface and the second transmissive reflective surface may have positive refractive power. Positive refractive power is necessary to converge a large light beam. At least one lens has negative refractive power to correct spherical aberration and curvature of field that occur with positive refractive power. In a case where at least two lenses with positive and negative refractive powers can be disposed, curvature of field can be corrected by the first transmissive reflective surface and the second transmissive reflective surface while spherical aberration and curvature of field can be corrected.

A lens with negative refractive power may be disposed adjacent to and on the enlargement side of the first transmissive reflective surface. Due to a lens with negative refractive power, off-axis light rays after passing through the lens with negative refractive power can have a large angle relative to the optical axis, and reflections from the first transmissive reflective surface and the second transmissive reflective surface can move the light rays in a direction perpendicular to the optical axis, and easily achieve telecentricity.

By disposing a lens with positive refractive power on the enlarging side of the lens with negative refractive power so as to arrange the lenses in the order of positive refractive power, negative refractive power, and the first transmissive reflective surface, spherical aberration and curvature of field can be corrected for light rays with a large aperture diameter.

The optical system according to each example includes a fully opened diaphragm. The fully opened diaphragm is a state in which an aperture stop is fully opened, and in each example, the state in which the aperture stop is fully opened is stored as a maximum aperture value, and at that time, the width of the on-axis light ray is determined by the maximum aperture value. In an optical system that has no aperture stop that can change the aperture diameter, the aperture that determines the on-axis light beam may be determined as the fully opened diaphragm. If there is an aperture that determines the on-axis light beam that falls within a range of inequality (2) described later, that aperture is determined as the fully opened diaphragm.

The optical system according to each example may be rotationally symmetrical with respect to the optical axis. In the optical system according to each example, the second transmissive reflective surface may be a surface with refractive power that is disposed closest to the reduction side of the optical system. The light beam can be moved in a direction perpendicular to the optical axis from the transmission point of the first transmissive reflective surface to the transmission point of the second transmissive reflective surface by the reflections of the first and second transmissive reflective surfaces, and the transmitting light beam is imaged at a point (sensor surface, panel plane) approximately parallel to the optical axis. In a case where another surface with refractive power is inserted between the transmission point of the second transmissive reflective surface and the image plane, unnecessary aberrations such as chromatic aberration will occur.

A description will be given of the conditions that may be satisfied by the optical system according to each example. The optical system according to each example may satisfy at least one of the following inequalities (1) to (16):

$$0.5 \leq fp / f \leq 10. \qquad ( 1 )$$

$$0. \leq Ls / L \leq 1. \qquad ( 2 )$$

$$0.03 \leq D / LD \leq 1.5 \qquad ( 3 )$$

$$- 2. \leq fF / fR \leq 10. \qquad ( 4 )$$

$$0.15 \leq Ld / La \leq 0.8 \qquad ( 5 )$$

$$0.5 \leq La / f \leq 3. \qquad ( 6 )$$

$$0.1 \leq Lh / L \leq 1. \qquad ( 7 )$$

$$0.3 \leq Lh / f \leq 3. \qquad ( 8 )$$

$$1.4 \leq nd \leq 2.3 \qquad ( 9 )$$

$$- 10. \leq fN / f \leq - 0.5 \qquad ( 10 )$$

$$- 0.5 \leq f / fR \leq 2. \qquad ( 11 )$$

$$0.05 \leq Li / L \leq 1. \qquad ( 12 )$$

$$- 1. \leq ( R 1 - R 2 ) / ( R 1 + R 2 ) \leq 1. \qquad ( 13 )$$

$$0.1 \leq Ld / f \leq 2. \qquad ( 14 )$$

$$0.1 \leq Oe / Ie \leq 2. \qquad ( 15 )$$

$$0.5 \leq Fno \leq 15. \qquad ( 16 )$$

Here, fp is a focal length of a lens with positive refractive power disposed on the enlargement side of a lens with negative refractive power disposed on the enlargement side of the first transmissive reflective surface. f is a focal length of the optical system. Ls is a distance on the optical axis from the fully opened diaphragm to the first transmissive reflective surface. L is an overall optical length, which is a distance on the optical axis from a first lens surface (an enlargement-side surface of a lens disposed closest to the enlargement side of the optical system) to the image plane (panel plane) including a member G such as a glass block. D is an aperture diameter of the fully opened diaphragm (maximum aperture diameter). LD is a distance on the optical axis from the fully opened diameter to the image plane (panel plane).

fR is a focal length in a range between the first transmissive reflective surface and the second transmissive reflective surface, and fF is a focal length in a range on an object side of the first transmissive reflective surface. La is an overall lens thickness, which is a thickness on the optical axis from a lens surface closest to the enlargement side (an enlargement-side surface of a lens closest to the enlargement side) to a lens surface closest to the reduction side (a reduction-side surface of a lens closest to the reduction side) of the optical system. Ld is a distance on the optical axis from the first transmissive reflective surface to the second transmissive reflective surface. Lh is a distance on the optical axis including a glass block from the first transmissive reflective surface to the image plane (panel plane).

nd is a refractive index for the d-line of a medium (material) other than air that fills a range between the first transmissive reflective surface and the second transmissive reflective surface. fN is a focal length of a negative lens disposed adjacent to and on the enlargement side of the first transmissive reflective surface. Li is a distance on the optical axis from the second transmissive reflective surface to the image plane (panel plane). R1 is a radius of curvature of the first transmissive reflective surface, and R2 is a radius of curvature of the second transmissive reflective surface. Oe is an outer diameter of a lens disposed closest to the enlargement side of the optical system, and Je is an outer diameter of a lens disposed closest to the reduction side of the optical system. In each example, an outer diameter of a lens is an effective diameter of the lens plus 2 mm.

Inequality (1) defines a focal length of a lens with positive refractive power disposed on the enlargement side of a lens with negative refractive power disposed on the enlargement side of the first transmissive reflective surface. Properly setting the positive refractive power can satisfactorily correct spherical aberration and curvature of field that occur with a light beam with a large aperture diameter. In a case where the value becomes lower than the lower limit of inequality (1), the refractive power of the positive lens becomes too strong, and a large spherical aberration amount occurs on the undercorrection side and it becomes difficult to correct it. On the other hand, in a case where the value becomes higher than the upper limit of inequality (1), the refractive power of the positive lens becomes too weak, and spherical aberration occurs on the overcorrection side.

Inequality (2) defines how far the fully opened diaphragm is from the first transmissive reflective surface to the enlargement side. The fully opened diaphragm is set at a position where an on-axis light beam and an off-axis light beam pass through the optical axis. Thus, the outer diameter of the lens usually increases as a position is farther from the fully opened diaphragm on the enlargement side or the reduction side. In a case where the distance between the fully opened diaphragm and the first transmissive reflective surface increases, the diameter of the lens disposed between the fully opened diaphragm and the first transmissive reflective surface increases. Thus, inequality (2) defines the size of the entire lens system.

In a case where the value becomes lower than the lower limit of inequality (2), the fully opened diaphragm is disposed between the first transmissive reflective surface and the second transmissive reflective surface, which is not practical. On the other hand, in a case where the value becomes higher than the upper limit of inequality (2), the fully opened diaphragm is disposed significantly closer to the object than the enlargement side of the first lens, and the diameter of the lens disposed between the fully opened diaphragm and the first transmissive reflective surface increases, and the size increase becomes so remarkable that telecentricity can be secured without using the reflections of the first and second transmissive reflective surfaces.

Inequality (3) defines the maximum aperture diameter of the fully opened diaphragm configured to determine the on-axis Fno light beam diameter, and a distance on the optical axis from the fully opened diaphragm to the image plane. In a case where the value becomes lower than the lower limit of inequality (3), the F-number that can be set in the specifications becomes dark and a light amount becomes insufficient. On the other hand, in a case where the value becomes higher than the upper limit of inequality (3), a light beam diameter increases and an image becomes too bright. As a result, the number of lenses for aberrational correction increases.

Inequality (4) defines a focal length of a range between the first transmissive reflective surface and the second transmissive reflective surface, and a focal length of a range on the object side of the first transmissive reflective surface. The structure is such that a light ray in the range between the first transmissive reflective surface and the second transmissive reflective surface is reflected so as to move in a direction perpendicular to the optical axis between the first transmissive reflective surface and the second transmissive reflective surface. To move the light ray, the shapes may be substantially similar, and in a case where the first transmissive reflective surface and the second transmissive reflective surface are considered as an integrated element with refractive power, strong refractive power is unnecessary. The shapes are similar between the first transmissive reflective surface and the second transmissive reflective surface, and a focal length is gentle and can be either positive or negative refractive power.

In a case where the value becomes lower than the lower limit of inequality (4), the focal length of the range on the object side of the first transmissive reflective surface becomes gentle relative to the range between the first transmissive reflective surface and the second transmissive reflective surface, and corrections of spherical aberration and curvature of field become insufficient. On the other hand, in a case where the value becomes higher than the upper limit of inequality (4), the focal length of the range on the object side of the first transmissive reflective surface becomes too gentle, and corrections of spherical aberration and curvature of field become insufficient.

Inequality (5) defines a distance (interval or gap) between the first transmissive reflective surface and the second transmissive reflective surface relative to the overall lens thickness of the optical system, that is, a thickness from a surface with a curvature disposed closest to the enlargement side to a surface disposed closest to the reduction side. In a case where the distance between the first transmissive reflective surface and the second transmissive reflective surface increases, the light ray can travel a longer distance between them, and a size reduction can be achieved.

In a case where the value becomes lower than the lower limit of inequality (5), the distance between the first transmissive reflective surface and the second transmissive reflective surface reduces, so the light ray must move perpendicular to the optical axis within the short distance. As a result, it becomes difficult to secure telecentricity when the light transmits through the second transmissive reflective surface. To secure telecentricity, a convex shape toward the enlargement side is to be enhanced, and an unnecessary air gap generated between the second transmissive reflective surface and the imaging point increases the size of the optical system. On the other hand, in a case where the value becomes higher than the upper limit of inequality (5), the distance between the first transmissive reflective surface and the second transmissive reflective surface increases relative to the optical system, and it becomes difficult to arrange lenses for aberrational correction and thus to correct aberration.

Inequality (6) defines an overall lens thickness of the optical system (the overall thickness on the optical axis of the lenses that constitute the optical system). The optical system using the first transmissive reflective surface and the second transmissive reflective surface can achieve a significant size reduction compared to optical systems that do not perform the normal reflection.

In a case where the value becomes lower than the lower limit of inequality (6), it is beneficial to an optical system having a reduced thickness and size. However, the excessively thin configuration reduces the distance (gap) between the first transmissive reflective surface and the second transmissive reflective surface. Moreover, in order to secure a moving distance in a direction perpendicular to the optical axis within this small range between the first transmissive reflective surface and the second transmissive reflective surface, the shapes of the first transmissive reflective surface and the second transmissive reflective surface are to be strongly convex toward the enlargement side, an unnecessary air gap is created between the second transmissive reflective surface and the imaging point, and the size of the optical system increases. On the other hand, in a case where the value becomes higher than the upper limit of inequality (6), the overall thickness of the lenses that constitute the optical system increases and the size of the optical system increases.

Inequality (7) defines the position of the first transmissive reflective surface relative to the overall optical length. As the first transmissive reflective surface is located closer on the enlargement side, a reflection distance between the first transmissive reflective surface and the second transmissive reflective surface can be longer, and the size reduction can be easily achieved.

In a case where the value becomes lower than the lower limit of inequality (7), the first transmissive reflective surface approaches excessively the imaging point, and a distance (gap) between the first transmissive reflective surface and the second transmissive reflective surface is effectively reduced. Since the light must be moved in a direction perpendicular to the optical axis within this narrow interval, it becomes difficult to secure telecentricity when the light transmits through the second transmissive reflective surface. In addition, in order to secure the telecentricity, the convex shape toward the enlargement side is to be enhanced, and an unnecessary air gap is created between the second transmissive reflective surface and the imaging point, and the size of the optical system increases. On the other hand, in a case where the value becomes higher than the upper limit of inequality (7), it becomes easier to secure the interval (distance) between the first transmissive reflective surface and the second transmissive reflective surface relative to the optical system. Nevertheless, it becomes difficult to place a lens for aberrational correction in a lens unit disposed on the enlargement side of the first transmissive reflective surface, and aberration correction becomes difficult.

Inequality (8) defines the position of the first transmissive reflective surface. As the first transmissive reflective surface becomes closer to the enlargement side, a reflection distance between the first transmissive reflective surface and the second transmissive reflective surface increases and the size reduction can be easily achieved.

In a case where the value becomes lower than the lower limit of inequality (8), it is beneficial to an entire optical system having a reduced thickness and size. However, the excessively thin configuration reduces the distance (gap) between the first transmissive reflective surface and the second transmissive reflective surface. Moreover, in order to secure a moving distance in a direction perpendicular to the optical axis within this small range between the first transmissive reflective surface and the second transmissive reflective surface, the shapes of the first transmissive reflective surface and the second transmissive reflective surface are to be strongly convex toward the enlargement side, an unnecessary air gap is created between the second transmissive reflective surface and the imaging point, and the size of the optical system increases. On the other hand, in a case where the value becomes higher than the upper limit of inequality (8), it becomes easier to secure the interval (distance) between the first transmissive reflective surface and the second transmissive reflective surface relative to the optical system. Nevertheless, it becomes difficult to place a lens for aberrational correction in a lens unit disposed on the enlargement side of the first transmissive reflective surface, and aberration correction becomes difficult.

Inequality (9) indicates that space between the first transmissive reflective surface and the second transmissive reflective surface is filled with a refractive index medium other than air. In a case where there is no refractive index medium and the surface is made of air only, it is difficult to achieve the relative positional accuracy between the first transmissive reflective surface and the second transmissive reflective surface, which causes performance degradation such as one-sided blur. The accuracy of the relative positional relationship can be secured by a integrally processable structure, such as a lens. In a case where the value becomes lower than the lower limit of inequality (9), the glass material cannot be processed, so the relative positional relationship between the first transmissive reflective surface and the second transmissive reflective surface is likely to shift, and negatively affect optical performance such as one-sided blur. On the other hand, in a case where the value becomes higher than the upper limit of inequality (9), there is no glass material and the gap becomes an air gap, so a reflective surface, etc. is to be used. Thus, the surface is to be held with a mechanical structure, and the relative positional relationship between the first transmissive reflective surface and the second transmissive reflective surface is likely to shift, and negatively affect optical performance such as one-sided blur.

Inequality (10) defines a focal length of the negative lens that is disposed adjacent to and on the enlargement side of the first transmissive reflective surface. In a case where the focal length of the negative lens is longer than the lower limit of inequality (10), the correction of the curvature of field becomes insufficient, and the insufficient negative refractive power must be borne by the lens on the enlargement side of the negative lens. In this case, the number of lenses increases and the size of the optical system increases. On the other hand, in a case where the focal length of the negative lens is shorter than the upper limit of inequality (10), it is beneficial to correct curvature of field. However, due to the excessive correction of curvature of field and a large moving amount between the first transmissive reflective surface and the second transmissive reflective surface in a direction perpendicular to the optical axis, it becomes difficult to secure telecentricity.

Inequality (11) defines a focal length between the first transmissive reflective surface and the second transmissive reflective surface. A light ray in the range between the first transmissive reflective surface and the second transmissive reflective surface is reflected so as to move in a direction perpendicular to the optical axis between the first transmissive reflective surface and the second transmissive reflective surface, and the shapes may be substantially similar to move the light ray. In a case where the first transmissive reflective surface and the second transmissive reflective surface are considered as an integrated element with refractive power, strong refractive power is unnecessary. In addition, the first transmissive reflective surface and the second transmissive reflective surface have similar shapes, and the focal length is gentle and can be either positive or negative refractive power. Thus, the focal length is large compared to the focal length of the optical system.

In a case where the value becomes lower than the lower limit of inequality (11), it becomes easier to secure a moving amount in a direction perpendicular to the optical axis between the first transmissive reflective surface and the second transmissive reflective surface. However, the focal length of the optical system becomes too short and the specifications cannot be met. On the other hand, in a case where the value becomes higher than the upper limit of inequality (11), the focal length between the first transmissive reflective surface and the second transmissive reflective surface becomes too short, a moving amount in a direction perpendicular to the optical axis becomes short, and it becomes difficult to secure telecentricity.

Inequality (12) defines a distance on the optical axis from the second transmissive reflective surface to the image plane. Since the first transmissive reflective surface and the second transmissive reflective surface have convex shapes, in a case where the distance on the optical axis from the second transmissive reflective surface to the image plane increases, unnecessary space is generated. In a case where the distance from the second transmissive reflective surface to the image plane reduces and becomes lower than the lower limit of inequality (12), interference occurs in the effective portion of the second transmissive reflective surface. On the other hand, in a case where the distance from the second transmissive reflective surface to the image plane becomes higher than the upper limit of inequality (12), there is no space to place a lens on the enlargement side of the first transmissive reflective surface, and it becomes difficult to correct spherical aberration and curvature of field in order to reduce the size of the optical system.

Inequality (13) defines a shape factor of the range between the first transmissive reflective surface and the second transmissive reflective surface. More specifically, it defines that the first transmissive reflective surface and the second transmissive reflective surface face in the same direction. A light ray is reflected to move in a direction perpendicular to the optical axis between the first transmissive reflective surface and the second transmissive reflective surface. To move the light ray, the shapes may be substantially similar. In a case where the value becomes higher than the upper limit of inequality (13) or lower than the lower limit of inequality (13), the convex or concave portions of the first transmissive reflective surface and the second transmissive reflective surface are to face each other. As a result, the light rays are hard to reach the image sensor due to reflections of the first transmissive reflective surface and the second transmissive reflective surface.

Inequality (14) defines a distance (gap) between the first transmissive reflective surface and the second transmissive reflective surface. In a case where the value becomes lower than the lower limit of inequality (14), the distance between the first transmissive reflective surface and the second transmissive reflective surface is reduced. As a result, the light ray is to move in a direction perpendicular to the optical axis within the short distance, and it becomes difficult to secure telecentricity when the light ray transmits through the second transmissive reflective surface. To secure telecentricity, the convex shape toward the enlargement side is to be enhanced, an unnecessary air gap is created between the second transmissive reflective surface and the imaging point, and the size of the optical system increases. On the other hand, in a case where the value becomes higher than the upper limit of inequality (14), the distance between the first transmissive reflective surface and the second transmissive reflective surface increases relative to the optical system, and it becomes difficult to place a lens for aberrational correction and thus correct aberration.

Inequality (15) relates to the outer diameter of the lens disposed closest to the enlargement side and the outer diameter of the lens disposed closest to the reduction side, and defines the size reduction. In each example, the outer diameter of the lens is a value obtained by adding 2 mm to the effective diameter of the lens. The structure is such that a light ray in the range between the first transmissive reflective surface and the second transmissive reflective surface is reflected so as to move in a direction perpendicular to the optical axis, and is a telecentric light ray. Therefore, the effective diameter of the light ray between the first transmissive reflective surface and the second transmissive reflective surface increases. However, Due to the setting of the position of the fully opened diaphragm, the effective diameter of the lens on the enlargement side of the first transmissive reflective surface can be reduced.

In a case where the value becomes lower than the lower limit of inequality (15), the outer diameter of the lens disposed closest to the enlargement side reduces, so that a light beam with the predetermined F-number cannot enter the lens, and the large aperture diameter becomes difficult. On the other hand, in a case where the value becomes higher than the upper limit of inequality (15), the outer diameter of the lens disposed closest to the enlargement side increases, and the weight of the optical system increases.

In the optical system according to each example, a light amount loss occurs due to the first transmissive reflective surface and the second transmissive reflective surface. Thus, in a case where the F-number is large, a light amount reaching the image sensor reduces. Accordingly, the optical system according to each example may satisfy inequality (16).

Inequalities (1) to (16) may be replaced with inequalities (1a) to (16a) below:

$$0.8 \leq fp / f \leq 8. \qquad ( 1 a )$$

$$0.02 \leq LS / L \leq 0.8 \qquad ( 2 a )$$

$$0.05 \leq D / LD \leq 1.2 \qquad ( 3 a )$$

$$- 1. \leq fF / fR \leq 5. \qquad ( 4 a )$$

$$0.2 \leq Ld / La \leq 0.7 \qquad ( 5 a )$$

$$0.6 \leq La / f \leq 2.8 \qquad ( 6 a )$$

$$0.2 \leq Lh / L \leq 0.9 \qquad ( 7 a )$$

$$0.4 \leq Lh / f \leq 2.5 \qquad ( 8 a )$$

$$1.45 \leq nd \leq 1.8 \qquad ( 9 a )$$

$$- 7. \leq fN / f \leq 1. \qquad ( 10 a )$$

$$- 0.2 \leq f / fR \leq 1. \qquad ( 11 a )$$

$$0.1 \leq Li / L \leq 0.85 \qquad ( 12 a )$$

$$- 0.9 \leq ( R 1 - R 2 ) / ( R 1 + R 2 ) \leq 0.8 \qquad ( 13 a )$$

$$0.2 \leq Ld / f \leq 1.5 \qquad ( 14 a )$$

$$0.15 \leq Oe / Ie \leq 1.2 \qquad ( 15 a )$$

$$0.7 \leq Fno \leq 12. \qquad ( 16 a )$$

Inequalities (1) to (16) may be replaced with inequalities (1b) to (16b) below:

$$1. \leq fp / f \leq 5. \qquad ( 1 b )$$

$$0.03 \leq Ls / L \leq 0.6 \qquad ( 2 b )$$

$$0.07 \leq D / LD \leq 1. \qquad ( 3 b )$$

$$0. \leq fF / fR \leq 1. \qquad ( 4 b )$$

$$0.24 \leq Ld / La \leq 0.6 \qquad ( 5 b )$$

$$0.7 \leq La / f \leq 2.6 \qquad ( 6 b )$$

$$0.3 \leq Lh / L \leq 0.8 \qquad ( 7 b )$$

$$0.5 \leq Lh / f \leq 2. \qquad ( 8 b )$$

$$1.48 \leq nd \leq 1.6 \qquad ( 9 b )$$

$$- 5. \leq fN / f \leq - 1. \qquad ( 10 b )$$

$$- 0.05 \leq f / fR \leq 0.3 \qquad ( 11 b )$$

$$0.15 \leq Li / L \leq 0.7 \qquad ( 12 b )$$

$$- 0.8 \; 0 \leq ( R 1 - R 2 ) / ( R 1 + R 2 ) \leq 0.60 \qquad ( 13 b )$$

$$0.3 \leq Ld / f \leq 0.9 \qquad ( 14 b )$$

$$0.2 \leq Oe / Ie \leq 1. \qquad ( 15 b )$$

$$0.9 \leq Fno \leq 10. \qquad ( 16 b )$$

### Configuration 1 Utilizing Polarization

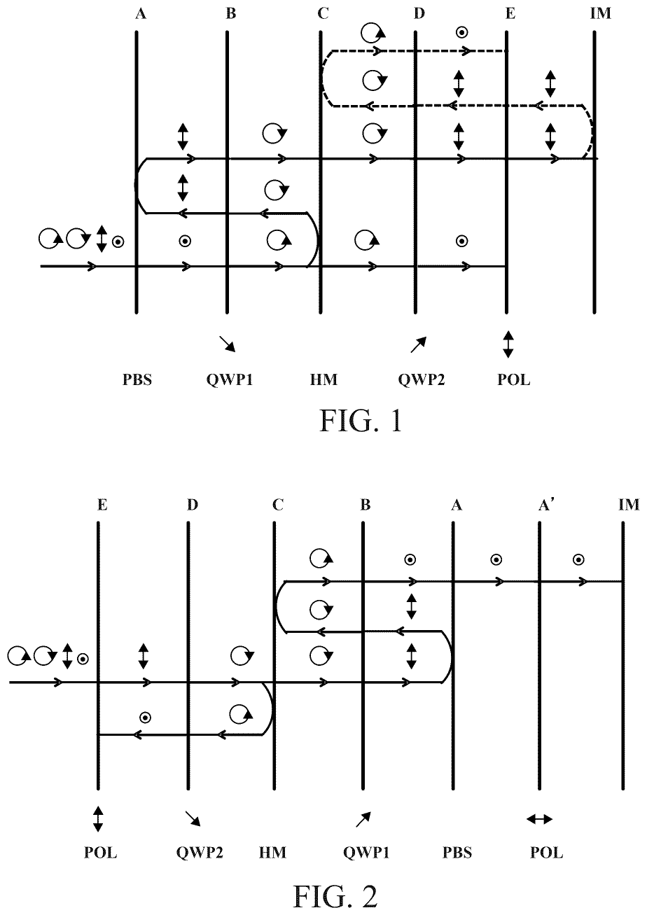

Referring now to FIG. 1, a description will be given of a configuration utilizing polarization (configuration 1). FIG. 1 is a schematic diagram illustrating an optical path of an optical system according to this example. The optical system according to this example includes two transmissive reflective surfaces. Here, the transmissive reflective surface disposed on the enlargement side of the optical system having this configuration includes a polarization-selective transmissive reflective element (polarizing beam splitter: PBS): A. The transmissive reflective surface disposed on the image plane side of the imaging optical system having this configuration includes a half-mirror (HM): C. A first quarter waveplate (QWP1): B is disposed between the polarization-selective transmissive reflective element PBS and the half-mirror HM. A second quarter waveplate (QWP2): D and a linear polarizer (POL): E are arranged, in order from the enlargement side to the reduction side, between the half-mirror HM and the image plane (imaging surface) IM.

Here, the polarization-selective transmissive reflective element A is an element configured to reflect linearly polarized light polarized in the same direction as that when it has transmitted through the linear polarizer E, and to transmit linearly polarized light perpendicular to this direction.

The polarization-selective transmissive reflective element A is, for example, a wire grid polarizer or a reflection type polarizer having a laminated retardation film configuration. At this time, the wire grid forming surface or retardation film surface of the polarization-selective transmissive reflective element A functions as a transmissive reflective surface. The wire grid polarizer does not necessarily have to be made of aligned metal wires, but may be anything including thin metal or dielectric layers arranged at predetermined intervals as long as it can function as a polarization-selective transmissive reflective element. For example, an element having metal or dielectric layers aligned by vapor deposition may be used.

The first quarter waveplate B and the second quarter waveplate D are arranged with their slow axes tilted at 45° relative to the polarization transmission axis of the linear polarizer E. Here, the first quarter waveplate B and the second quarter waveplate D may be arranged with their slow axes tilted at 90°. Due to this arrangement, in a case where a ray transmits through the first quarter waveplate B and the second quarter waveplate D, the wavelength dispersion characteristics of the waveplates are canceled out. The half-mirror C is a half-mirror formed, for example, by a dielectric multilayer film or metal deposition, and the surface of the half-mirror C functions as a transmissive reflective surface. The linear polarizer E is, for example, an absorption type linear polarizer.

A description will now be given of the optical path selection and function in the configuration utilizing polarization. Light incident on the optical system from the enlargement side becomes linearly polarized light by the polarization-selective transmissive reflective element A, becomes circularly polarized light by the first quarter waveplate B, and enters the half-mirror C. A part of the light that reaches the half-mirror C is reflected, becomes circularly polarized in the reverse direction, and returns to the first quarter waveplate B.

The reverse-circularly polarized light that has returned to the first quarter waveplate B returns to the polarization-selective transmissive reflective element A by the first quarter waveplate B as linearly polarized light polarized in a direction orthogonal to the direction when the light first transmitted through the polarization-selective transmissive reflective element A. The light that has returned to the polarization-selective transmissive reflective element A is reflected by the polarization-selective transmissive reflective element A. Here, due to the polarization selectivity of the polarization-selective transmissive reflective element A, linearly polarized light polarized in the direction perpendicular to the direction when the light first passed the polarization-selective transmissive reflective element A is reflected.

A part of the light that has reached the half-mirror C transmits through it, becomes linearly polarized light by the second quarter waveplate D polarized in the same direction as that when the light passed the polarization-selective transmissive reflective element A, enters the linear polarizer E, and is absorbed by the linear polarizer E.

The light reflected by the polarization-selective transmissive reflective element A becomes circularly polarized by the first quarter waveplate B and enters the half-mirror C. A part of the light that has reached the half-mirror C transmits through it and enters the second quarter waveplate D. Due to the second quarter waveplate D, the incident light becomes linearly polarized light polarized in a direction parallel to that of the linearly polarized light reflected by the polarization-selective transmissive reflective element A. The light that transmits through the second quarter waveplate D enters the linear polarizer E. Here, the polarization of the light and the transmission axis of the linear polarizer E match, so most of the light transmits and is guided to the image plane IM.

Due to the above action, only the light that transmits through the polarization-selective transmissive reflective element PBS, is reflected by the half-mirror C, is reflected by the polarization-selective transmissive reflective element PBS, and transmits through the half-mirror C is guided to the image plane IM.

In a case where a cholesteric liquid crystal is used instead of the half-mirror C, the cholesteric liquid crystal may be installed so that during the first reflection of the cholesteric liquid crystal, circularly polarized light in a direction of incident light is largely reflected. Thus, a light amount on the normal optical path can be increased while ghost light is reduced.

Solid-state image sensors and Charge Coupled Devices (CCDs) that can be used for the image plane IM generally have high surface reflectance. In this configuration, the light reflected on the image plane IM transmits through the linear polarizer E again and is converted into circularly polarized light by the second quarter waveplate D. The light emitted from the second quarter waveplate D is then reflected on the half-mirror C, becomes circularly polarized light in the opposite direction, and transmits through the second quarter waveplate D again. At this time, the circularly polarized light is converted by the second quarter waveplate D into linearly polarized light polarized in a direction perpendicular to that of the light that has just transmitted through the linear polarizer E. Since the direction of this linearly polarized light is orthogonal to the transmission axis of the linear polarizer E, most of the light is absorbed by the linear polarizer E. Thus, in this configuration, most of the light that is reflected on the image plane IM and the half-mirror C in this order is cut off, ghosts and flares relating to the image plane IM are less conspicuous. In order to obtain such a reflection reducing effect, no optical low-pass filter using birefringence may be disposed between the image plane IM and the linear polarizer E. This is because the optical low-pass filter causes the polarization state to shift from the desired polarization state.

In this configuration, a quarter waveplate may be disposed between the polarization-selective transmissive reflective element A and the object. In this case, the quarter waveplate is disposed so that an angle between the fast axis or slow axis of the quarter waveplate and the transmission axis of the polarization-selective transmissive reflective element A is 45°. In this way, even if the light incident from the enlargement side is linearly polarized, imaging can be performed regardless of its polarization direction. A depolarizing element may be placed instead of the quarter waveplate. For example, “Cosmoshine SRF” manufactured by Toyobo Co., Ltd. can be used as the depolarizing element.

### Configuration 2 Utilizing Polarization

Referring now to FIG. 2, a description will be given of a configuration utilizing polarization (configuration 2). FIG. 2 is a schematic diagram of an optical path of an optical system according to each example. The optical system having this configuration includes two transmissive reflective surfaces. Here, the transmissive reflective surface disposed on the enlargement side of the optical system having this configuration includes a half-mirror (HM): C. The transmissive reflective surface disposed on the image plane side of the optical system having this configuration includes a polarization-selective transmissive reflective element (PBS): A. A first quarter waveplate (QWP1): B is disposed between the polarization-selective transmissive reflective element PBS and the half-mirror HM. A linear polarizer (POL): E and a second quarter waveplate (QWP2): D are arranged, in order from the enlargement side to the reduction side, between the half-mirror HM and the object surface. The configuration of each polarizing element and the suitable arrangement of the optical axis direction are similar to those of the configuration 1 utilizing the polarization.

A description will now be given of the optical path selection and action in the configuration utilizing polarization. Light incident on the optical system from the enlargement side becomes linearly polarized light by the linear polarizer E, becomes circularly polarized light by the second quarter waveplate D, and enters the half-mirror C. A part of the light that has reached the half-mirror C is reflected, becomes circularly polarized light in the opposite direction, and returns to the second quarter waveplate D. The light that reaches and is reflected by the half-mirror C becomes circularly polarized light in the opposite direction to the incident direction. This light is converted by the second quarter waveplate D into linearly polarized light polarized in a direction perpendicular to the direction when it transmitted through the linear polarizer E, enters the linear polarizer E, and is absorbed by the linear polarizer E.

On the other hand, the light that has transmitted through the half-mirror C is converted by the first quarter waveplate B into linearly polarized light polarized in the same direction as that of the light that has just transmitted through the linear polarizer E. Thereafter, the light is converted into circularly polarized light by the first quarter waveplate B, and part of it is reflected by the half-mirror C. The light reflected by half-mirror C enters first quarter waveplate B again and is converted into linearly polarized light whose polarization direction is orthogonal to that when it was reflected by polarization-selective transmission reflector A. This linearly polarized light transmits through polarization-selective transmission reflector A and is guided to the image plane IM.

Due to the above action, only the light that transmits through the half-mirror C, is reflected on the polarization-selective transmissive reflective element PBS, is reflected on the half-mirror C, and transmits through the polarization-selective transmissive reflective element PBS is guided to the image plane IM.

Due to this arrangement, a linear polarizer A′ may be placed between the polarization-selective transmissive reflective element A and the image plane IM. In this case, the transmission axes of the linear polarizer A′ and the polarization-selective transmissive reflective element Aare made to coincide. This configuration can absorb light that is reflected at the image plane IM, is reflected at the polarization-selective transmissive reflective element A, and enters the image plane IM again, and becomes ghosts or flares.

Due to this configuration, a quarter waveplate may be placed between the linear polarizer E and the object. In this case, the quarter waveplate is placed so that an angle between the fast axis or slow axis of the quarter waveplate and the transmission axis of the linear polarizer E is 45°. Thus, even if the light from the enlargement side is linearly polarized, imaging can be performed regardless of its polarization direction. A depolarizing element may be placed instead of the quarter waveplate. For example, “Cosmoshine SRF” by Toyobo Co., Ltd. can be used as the depolarizing element.

Although terms such as orthogonal, parallel, and 45° are used in the description of the above configuration, they do not have to be strictly 90°, 0°, and 45°, as long as they are within ±5° of the desired angle, or within ±2° of the desired angle, or within ±1° of the desired angle.

In the optical systems according to each example, the lenses may be made of polymer or glass materials. However, the lens placed between the first transmissive reflective surface and the second transmissive reflective surface may have low birefringence.

### Configuration 3 Utilizing Polarization

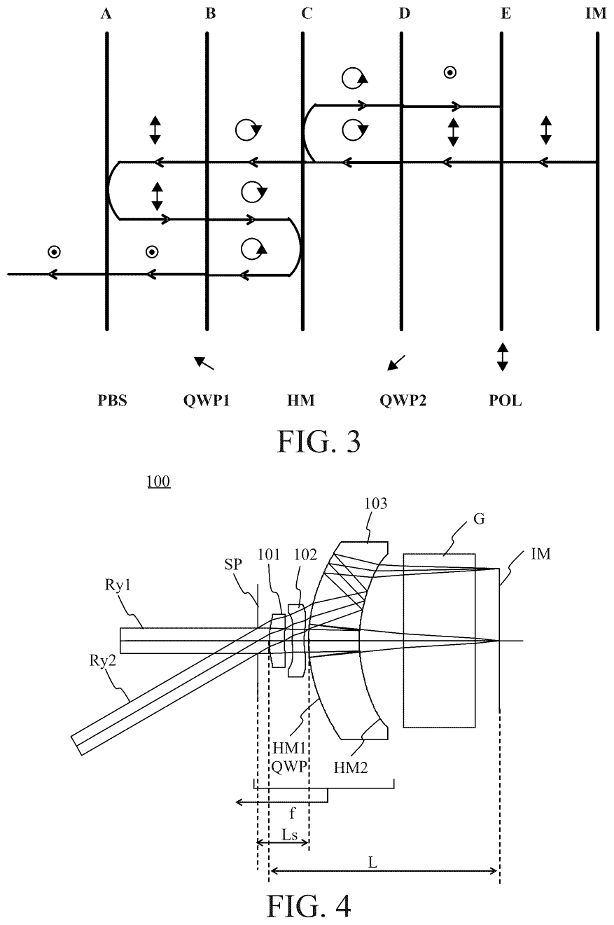

Referring to FIG. 3, a description will be given of a configuration utilizing polarization (configuration 3). FIG. 3 is a schematic diagram of an optical path of an optical system according to each example. This configuration assumes a configuration in which a light source panel is disposed on the image plane IM instead of an image sensor, and is an optical system configured to project light from the light source panel to the enlargement side. The image plane IM is a panel plane of a light-emitting panel such as a Liquid Crystal On Silicon (LCOS) panel or a Digital Micromirror Device (DMD) panel. The configuration in FIG. 3 is the same as that of FIG. 1, but a light passing direction is reversed.

The optical system having this configuration includes two transmissive reflective surfaces. Here, a transmissive reflective surface disposed on the enlargement side of the optical system having this configuration is constructed by placing a polarization-selective transmissive reflective element (PBS): A. A transmissive reflective surface disposed on the image plane side of the optical system having this configuration is constructed by placing a half-mirror (HM): C. A first quarter waveplate (QWP1): B is disposed between the polarization-selective transmissive reflective element PBS and the half-mirror HM. A second quarter waveplate (QWP2): D and a linear polarizer (POL): E are arranged, in order from the enlargement side to the reduction side, between the half-mirror HM and the image plane IM.

Here, the polarization-selective transmissive reflective element A is an element configured to reflect linearly polarized light polarized in the same direction as that when it has transmitted through the linear polarizer E, and to transmit linearly polarized light polarized in a direction perpendicular to this direction. The polarization-selective transmissive reflective element A is, for example, a wire grid polarizer or a reflection-type polarizer with a phase difference film stack configuration. At this case, the wire grid forming surface or the phase difference film surface of the polarization-selective transmissive reflective element A functions as a transmissive reflective surface. The wire grid polarizer does not necessarily have to be one in which metal wires are aligned, but it may have thin metal or dielectric layers arranged at a predetermined interval and function as a polarization-selective transmissive reflective element. For example, an element in which metal or dielectric layers are aligned by deposition can be used.

The first quarter waveplate B and the second quarter waveplate D are arranged so that their slow axes tilt at 45° relative to the polarization transmission axis of the linear polarizer E. Here, the first quarter waveplate B and the second quarter waveplate D may be arranged so that their respective slow axes tilt by 90°. Due to this arrangement, the wavelength dispersion characteristics of the waveplate are canceled when a light ray transmits through the first quarter waveplate B and the second quarter waveplate D.

The half-mirror C is formed, for example, by a dielectric multilayer film or metal deposition, and the mirror surface of the half-mirror C functions as a transmissive reflective surface. The linear polarizer E is, for example, an absorption-type linear polarizer.

A description will now be given of the optical path selection and action in the configuration utilizing polarization. The image plane IM is a panel plane of the light emitting panel such as an LCOS panel or a DMD panel, and utilizes light from a laser light source reflected by the panel plane. Since the laser beam has a uniform polarization direction, light with uniform polarization is emitted from the image plane IM as the panel plane.

The linearly polarized light emitted from the image plane IM transmits through the linear polarizer E as linearly polarized light. Light as the linearly polarized light becomes circularly polarized light by the second quarter waveplate D and enters the half-mirror C. Part of the light that has reached the half-mirror C transmits it, becomes linearly polarized light by the first quarter waveplate B, is reflected by the polarization-selective transmissive reflective element PBS, becomes circularly polarized light by the first quarter waveplate B again, and enters the half-mirror C. Part of the light that has reached the half-mirror C is reflected, becomes circularly polarized in the reverse direction, and returns to the first quarter waveplate B. The reverse circularly polarized light returning to the first quarter waveplate B becomes linearly polarized light by the first quarter waveplate B, transmits through the polarization-selective transmissive reflective element A, and is emitted as linearly polarized light to the enlargement side. On the other hand, part of the light that has reached the half-mirror C is reflected and becomes reverse circularly polarized light, is converted into linearly polarized light by the second quarter waveplate D, enters the linear polarizer E, and is absorbed by the linear polarizer E.

Due to the above action, the light emitted at the image plane IM is reflected by the polarization-selective transmissive reflective element PBS, is reflected by the half-mirror C, and is guided to the object. In a case where a cholesteric liquid crystal is used instead of the half-mirror C, the cholesteric liquid crystal may be disposed so that the first reflection of the cholesteric liquid crystal reflects a large amount of circularly polarized light in the direction of the incident light. Thus, a light amount in the normal optical path can be increased while ghost light is reduced.

The configuration of the optical system according to each example will be described below.

### Example 1

A description will now be given of an optical system 100 according to Example 1. FIG. 4 is a sectional view of the optical system 100 in an in-focus state (on an object) at infinity. The optical system 100 includes, in order from the enlargement side to the reduction side, a fully opened diaphragm (aperture stop) SP, a first positive lens (first lens) 101, and a second negative lens (second lens) 102. The optical system 100 further includes, in order from the enlargement side to the reduction side, a third lens 103 with a first transmissive reflective surface HM1 and a second transmissive reflective surface HM2, and a member G such as a glass block such as a prism and a sensor protection glass. The third lens 103 includes a quarter waveplate QWP on the reduction side of the first transmissive reflective surface HM1.

The first positive lens 101, the second negative lens 102, and the third lens 103 form a focusing unit f. Focusing is performed by integrally moving each lens that forms the focusing unit f in the optical axis direction. Ry1 is an on-axis light ray, and Ry2 is the most off-axis light ray. The optical system 100 is configured to guide the on-axis light ray Ry1 to the image plane IM.

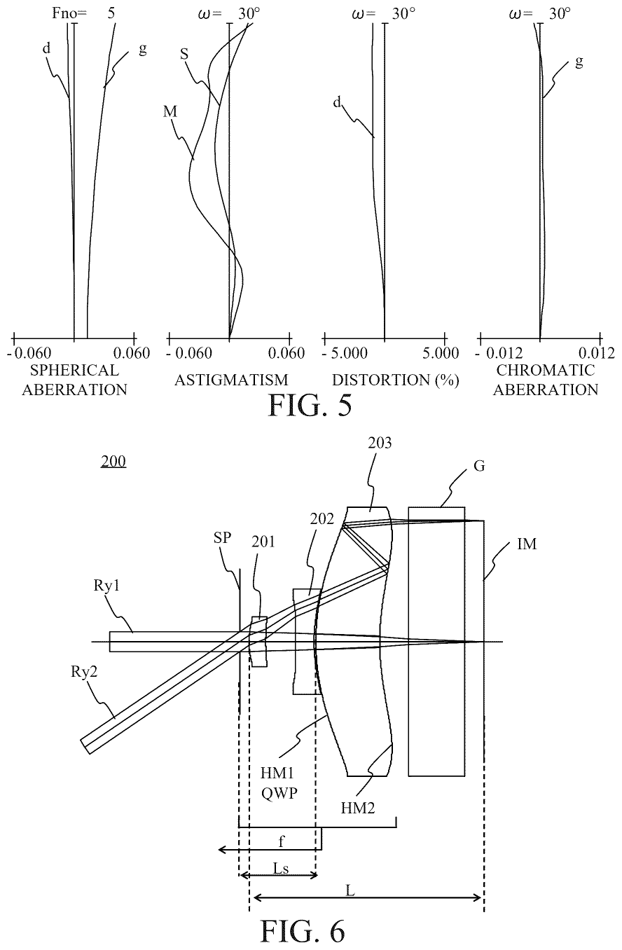

FIG. 5 illustrates an aberration diagram of the optical system 100 in an in-focus state at infinity. In a spherical aberration diagram, Fno represents an F-number. The spherical aberration diagram illustrates spherical aberration amounts for the d-line (with a wavelength of 587.6 nm) and the g-line (with a wavelength of 435.8 nm). In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 100 is used as a projection optical system (an optical system for a projection apparatus), the enlargement side is a projection side, and the reduction side is a light source panel side. In a case where the optical system 100 is used as an imaging optical system, the enlargement side is an object side, and the reduction side is an image side.

### Example 2

A description will now be given of an optical system 200 according to Example 2. FIG. 6 is a sectional view of the optical system 200 in an in-focus state at infinity. The optical system 200 includes, in order from the enlargement side to the reduction side, a fully opened diaphragm (aperture stop) SP, a first positive lens (first lens) 201, and a second negative lens (second lens) 202. The optical system 200 further includes, in order from the enlargement side to the reduction side, a third lens 203 with a first transmissive reflective surface HM1 and a second transmissive reflective surface HM2 and a member G such as a glass block such as a prism and a sensor protective glass. The third lens 203 includes a quarter waveplate QWP on the reduction side of the first transmissive reflective surface HM1. A focusing unit f includes the first positive lens 201, the second negative lens 202, and the third lens 203. Focusing is performed by integrally moving each lens constituting the focusing unit f in the optical axis direction. Ry1 is an on-axis light ray, and Ry2 is the most off-axis light ray. The optical system 200 is configured to guide the on-axis light ray Ry1 to an image plane IM.

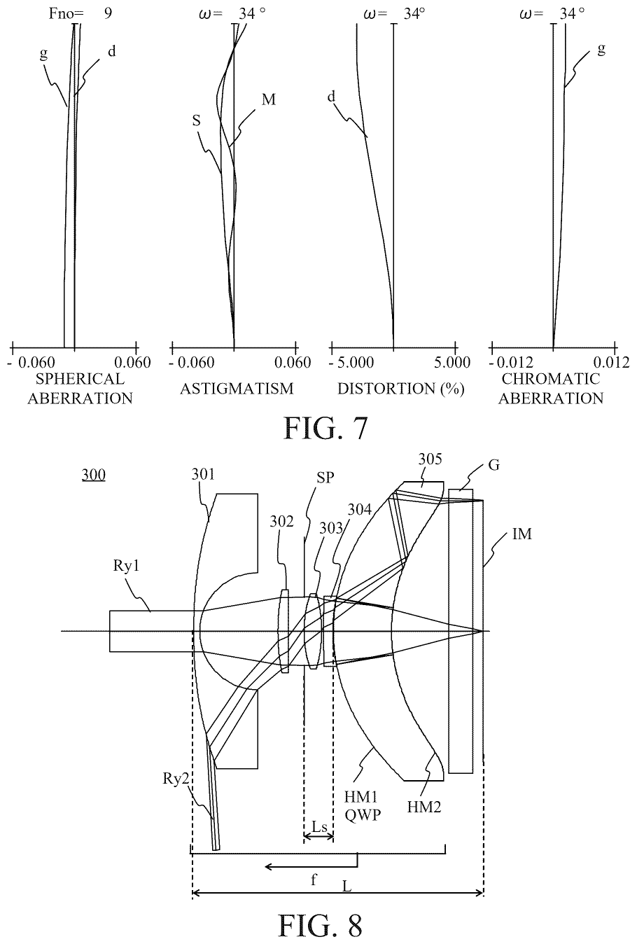

FIG. 7 illustrates an aberration diagram of the optical system 200 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 200 is used as a projection optical system, the enlargement side is a projection side, and the reduction side is a light source panel side. In a case where the optical system 200 is used as an imaging optical system, the enlargement side is an object side, and the reduction side is an image side.

### Example 3

A description will now be given of an optical system 300 according to Example 3. FIG. 8 is a sectional view of the optical system 300 in an in-focus state at infinity. The optical system 300 includes, in order from the enlargement side to the reduction side, a first negative lens 301, a second positive lens 302, a fully opened diaphragm (aperture stop) SP, a third positive lens 303, and a fourth negative lens 304. The optical system 300 further includes, in order from the enlargement side to the reduction side, a fifth lens 305 having a first transmissive reflective surface HM1 and a second transmissive reflective surface HM2, and a member G such as a glass block such as a prism and a sensor protection glass. The fifth lens 305 includes a quarter waveplate QWP on the reduction side of the first transmissive reflective surface HM1. The first negative lens 301, the second positive lens 302, the third positive lens 303, the fourth negative lens 304, and the fifth lens 305 constitute a focusing unit f. Focusing is performed by integrally moving each lens constituting the focusing unit f in the optical axis direction. Ry1 is an on-axis light ray, and Ry2 is the most off-axis light ray. The optical system 300 is configured to guide the on-axis light ray Ry1 to the image plane IM.

In this example, the first lens is one of the first negative lens 301, the second positive lens 302, and the third positive lens 303. The second lens is one of the second positive lens 302, the third positive lens 303, and the fourth negative lens 304, and is disposed on the reduction side of the first lens.

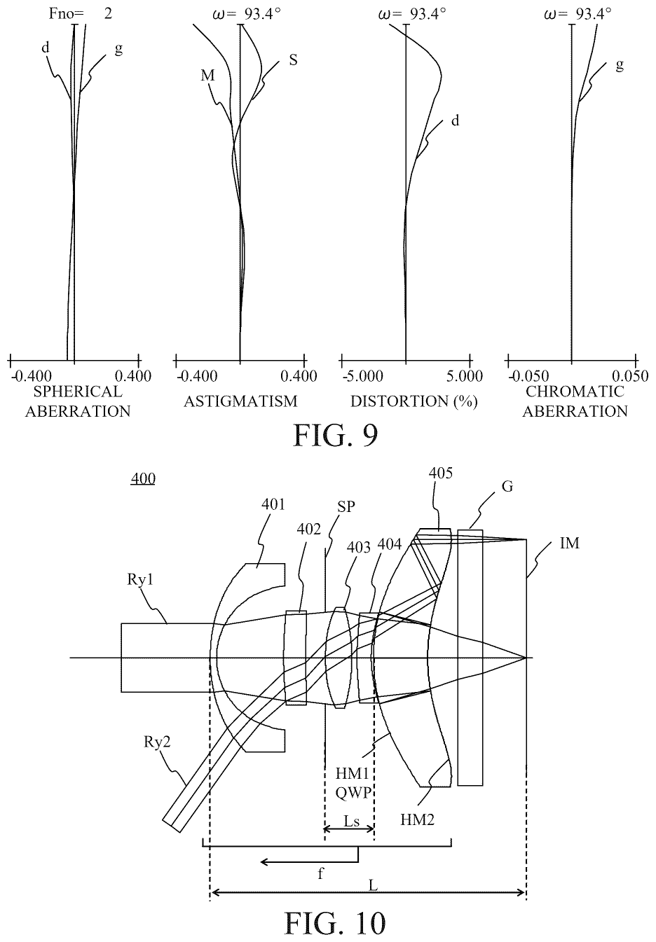

FIG. 9 is an aberration diagram of the optical system 300 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 300 is used as a projection optical system, the enlargement side is a projection side, and the reduction side is a light source panel side. In a case where the optical system 300 is used as an imaging optical system, the enlargement side is an object side, and the reduction side is an image side.

### Example 4

A description will now be given of an optical system 400 according to Example 4. FIG. 10 is a sectional view of the optical system 400 in an in-focus state at infinity. The optical system 400 includes, in order from the enlargement side to the reduction side, a first negative lens 401, a second positive lens 402, a fully opened diaphragm (aperture stop) SP, a third positive lens 403, and a fourth negative lens 404. The optical system 400 further includes, in order from the enlargement side to the reduction side, a fifth lens 405 having a first transmissive reflective surface HM1 and a second transmissive reflective surface HM2, and a member G such as a glass block such as a prism and a sensor protective glass. The fifth lens 405 includes a quarter waveplate QWP on the reduction side of the first transmissive reflective surface HM1. The first negative lens 401, the second positive lens 402, the third positive lens 403, the fourth negative lens 404, and the fifth lens 405 constitute a focusing unit f. Focusing is performed by integrally moving each lens that constitutes the focusing unit f in the optical axis direction. Ry1 is an on-axis light ray, and Ry2 is the most off-axis light ray. The optical system 400 is configured to guide the on-axis light ray Ry1 to the image plane IM.

In this example, the first lens is one of the first negative lens 401, the second positive lens 402, and the third positive lens 403. The second lens is one of the second positive lens 402, the third positive lens 403, and the fourth negative lens 404, and is disposed on the reduction side of the first lens.

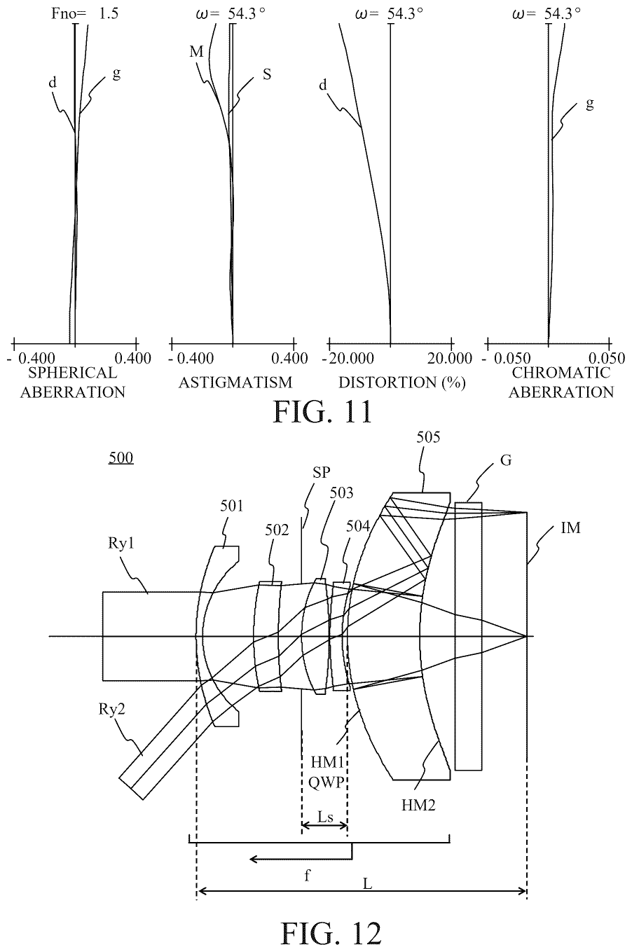

FIG. 11 is an aberration diagram of the optical system 400 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 400 is used as a projection optical system, the enlargement side is a projection side, and the reduction side is a light source panel side. In a case where the optical system 400 is used as an imaging optical system, the enlargement side is an object side, and the reduction side is an image side.

### Example 5

A description will now be given of an optical system 500 according to Example 5. FIG. 12 is a sectional view of the optical system 500 in an in-focus state at infinity. The optical system 500 includes, in order from the enlargement side to the reduction side, a first negative lens 501, a second positive lens 502, a fully opened diaphragm (aperture stop) SP, a third positive lens 503, and a fourth negative lens 504. The optical system 500 further includes, in order from the enlargement side to the reduction side, a fifth lens 505 having a first transmissive reflective surface HM1 and a second transmissive reflective surface HM2, and a member G such as a glass block such as a prism and a sensor protective glass. The fifth lens 505 includes a quarter waveplate QWP on the reduction side of the first transmissive reflective surface HM1. The first negative lens 501, the second positive lens 502, the third positive lens 503, the fourth negative lens 504, and the fifth lens 505 constitute a focusing unit f Focusing is performed by integrally moving each lens that forms the focusing unit f in the optical axis direction. Ry1 is an on-axis light ray, and Ry2 is the most off-axis light ray. The optical system 500 is configured to guide the on-axis light ray Ry1 to the image plane IM.

In this example, the first lens is one of the first negative lens 501, the second positive lens 502, and the third positive lens 503. The second lens is one of the second positive lens 502, the third positive lens 503, and the fourth negative lens 504, and is disposed on the reduction side of the first lens.

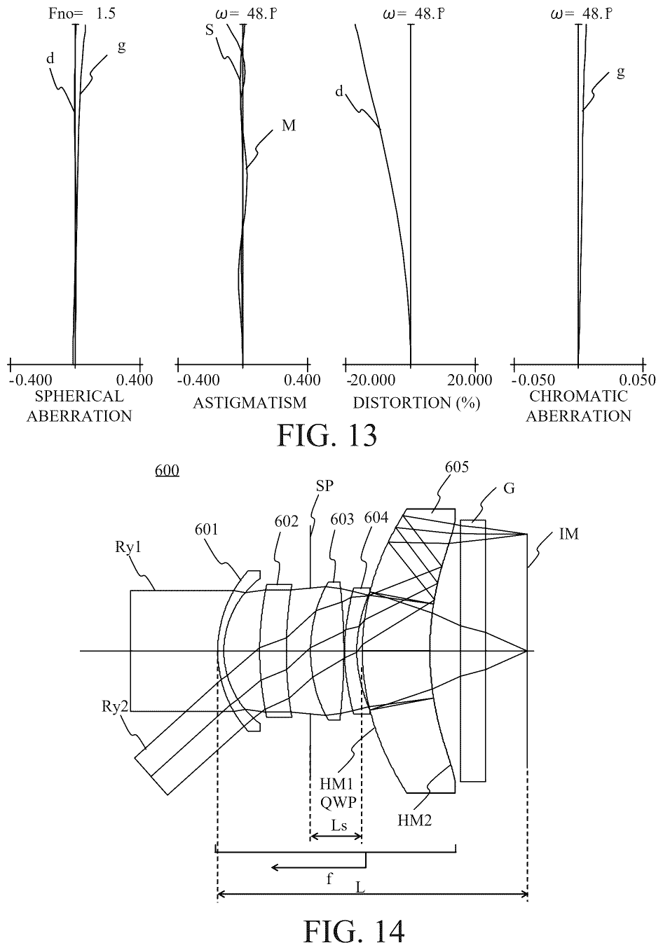

FIG. 13 is an aberration diagram of the optical system 500 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 500 is used as a projection optical system, the enlargement side is a projection side, and the reduction side is a light source panel side. In a case where the optical system 500 is used as an imaging optical system, the enlargement side is an object side, and the reduction side is an image side.

### Example 6

A description will now be given of an optical system 600 according to Example 6. FIG. 14 is a sectional view of the optical system 600 in an in-focus state at infinity. The optical system 600 includes, in order from the enlargement side to the reduction side, a first negative lens 601, a second positive lens 602, a fully opened diaphragm (aperture stop) SP, a third positive lens 603, and a fourth negative lens 604. The optical system 600 further includes, in order from the enlargement side to the reduction side, a fifth lens 605 with a first transmissive reflective surface HM1 and a second transmissive reflective surface HM2, and a member G such as a glass block such as a prism and a sensor protective glass. The fifth lens 605 includes a quarter waveplate QWP on the reduction side of the first transmissive reflective surface HM1. The first negative lens 601, the second positive lens 602, the third positive lens 603, the fourth negative lens 604, and the fifth lens 605 constitute a focusing unit f. Focusing is performed by integrally moving each lens constituting the focusing unit f in the optical axis direction. Ry1 is an on-axis light ray, and Ry2 is the most off-axis light ray. The optical system 600 is configured to guide the on-axis light ray Ry1 to the image plane IM.

In this example, the first lens is one of the first negative lens 601, the second positive lens 602, and the third positive lens 603. The second lens is one of the second positive lens 602, the third positive lens 603, and the fourth negative lens 604, and is disposed on the reduction side of the first lens.

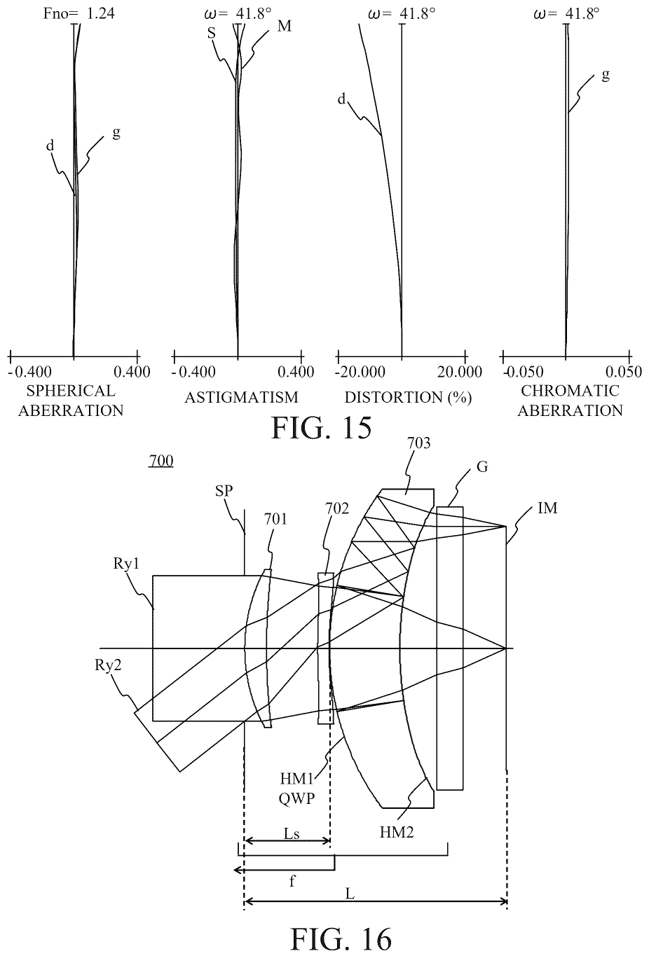

FIG. 15 is an aberration diagram of the optical system 600 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 600 is used as a projection optical system, the enlargement side is a projection side, and the reduction side is a light source panel side. In a case where the optical system 600 is used as an imaging optical system, the enlargement side is an object side, and the reduction side is an image side.

### Example 7

A description will now be given of an optical system 700 according to Example 7. FIG. 16 is a sectional view of the optical system 700 in an in-focus state at infinity. The optical system 700 includes, in order from the enlargement side to the reduction side, a fully opened diaphragm (aperture stop) SP, a first positive lens (first lens) 701, and a second negative lens (second lens) 702. The optical system 700 further includes, in order from the enlargement side to the reduction side, a third lens 703 with a first transmissive reflective surface HM1 and a second transmissive reflective surface HM2, and a member G such as a glass block such as a prism and a sensor protective glass. The third lens 703 includes a quarter waveplate QWP on the reduction side of the first transmissive reflective surface HM1. Ry1 is an on-axis light ray, and Ry2 is the most off-axis light ray. The optical system 700 is configured to guide the on-axis light ray Ry1 to the image plane IM.

The first positive lens 701, the second negative lens 702, and the third lens 703 constitute a focusing unit f. Focusing is performed by integrally moving each lens that forms the focusing unit f in the optical axis direction.

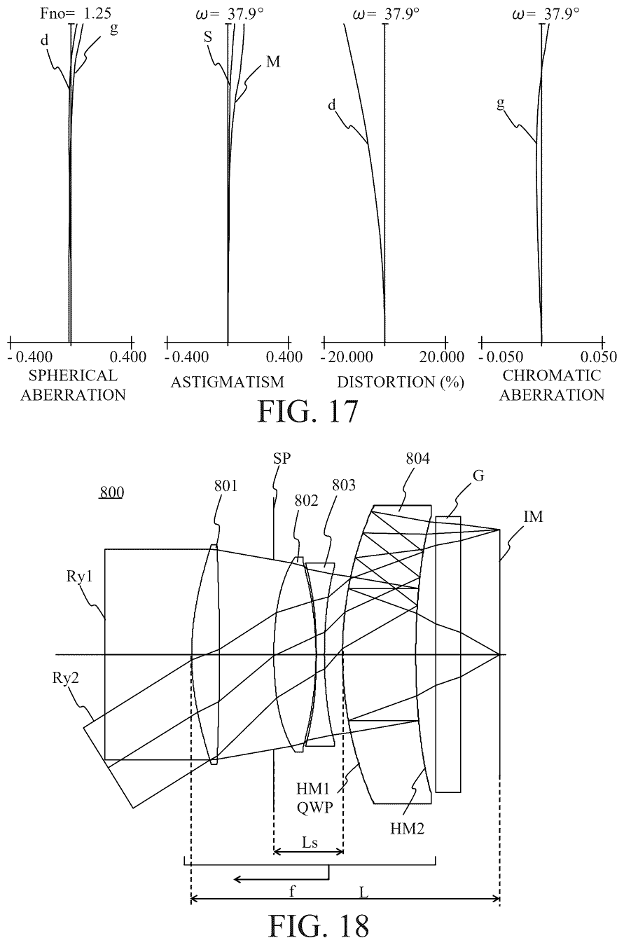

FIG. 17 is an aberration diagram of the optical system 700 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 700 is used as a projection optical system, the enlargement side is a projection side, and the reduction side is a light source panel side. In a case where the optical system 700 is used as an imaging optical system, the enlargement side is an object side, and the reduction side is an image side.

### Example 8

A description will now be given of an optical system 800 according to Example 8. FIG. 18 is a sectional view of the optical system 800 in an in-focus state at infinity. The optical system 800 includes, in order from the enlargement side to the reduction side, a first positive lens 801, a fully opened diaphragm (aperture stop) SP, a second positive lens 802, and a third negative lens 803. The optical system 800 further includes, in order from the enlargement side to the reduction side, a fourth lens 804 having a first transmissive reflective surface HM1 and a second transmissive reflective surface HM2, and a member G such as a glass block such as a prism and a sensor protective glass. The fourth lens 804 includes a quarter waveplate QWP on the reduction side of the first transmissive reflective surface HM1. The first positive lens 801, the second positive lens 802, the third negative lens 803, and the fourth lens 804 constitute a focusing unit f. Focusing is performed by integrally moving each lens that forms the focusing unit f in the optical axis direction. Ry1 is an on-axis light ray, and Ry2 is the most off-axis light ray. The optical system 800 is configured to guide the on-axis light ray Ry1 to the image plane IM.

In this example, the first lens is one of the first positive lens 801 or the second positive lens 802. The second lens is one of the second positive lens 802 or the third negative lens 803, and is disposed on the reduction side of the first lens.

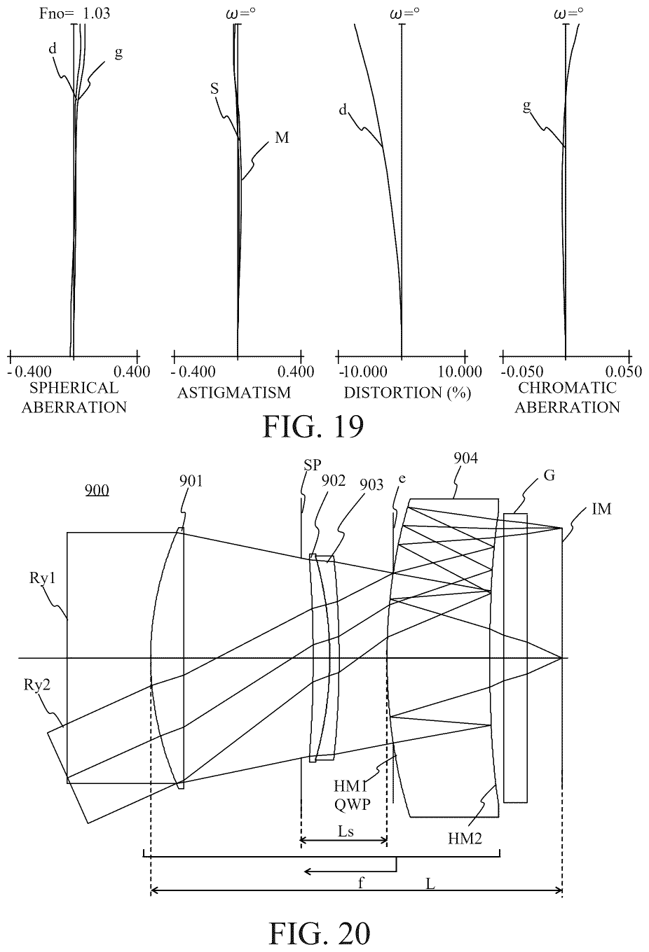

FIG. 19 is aberration diagrams of optical system 800 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 800 is used as a projection optical system, the enlargement side is a projection side, and the reduction side is a light source panel side. In a case where the optical system 800 is used as an imaging optical system, the enlargement side is an object side, and the reduction side is an image side.

### Example 9

A description will now be given of an optical system 900 according to Example 9. FIG. 20 is a sectional view of the optical system 900 in an in-focus state at infinity. The optical system 900 includes, in order from the enlargement side to the reduction side, a first positive lens 901, a fully opened diaphragm (aperture stop) SP, a cemented lens formed by cementing a second positive lens 902 and a third negative lens 903. The optical system 900 further includes, in order from the enlargement side to the reduction side, a fourth lens 904 having a first transmissive reflective surface HM1 and a second transmissive reflective surface HM2, and a member G such as a glass block such as a prism and a sensor protective glass. The fourth lens 904 includes a quarter waveplate QWP on the reduction side of the first transmissive reflective surface HM1. The first positive lens 901, the second positive lens 902, the third negative lens 903, and the fourth lens 904 constitute a focusing unit f. Focusing is performed by integrally moving each lens of the focusing unit f in the optical axis direction. Ry1 is an on-axis light ray, and Ry2 is the most off-axis light ray. The optical system 900 is configured to guide the on-axis light ray Ry1 to the image plane IM. e is a flare cut diaphragm configured to cut unnecessary light.

In this example, the first lens is either the first positive lens 901 or the second positive lens 902. The second lens is either the second positive lens 902 or the third negative lens 903, and is disposed on the reduction side of the first lens.

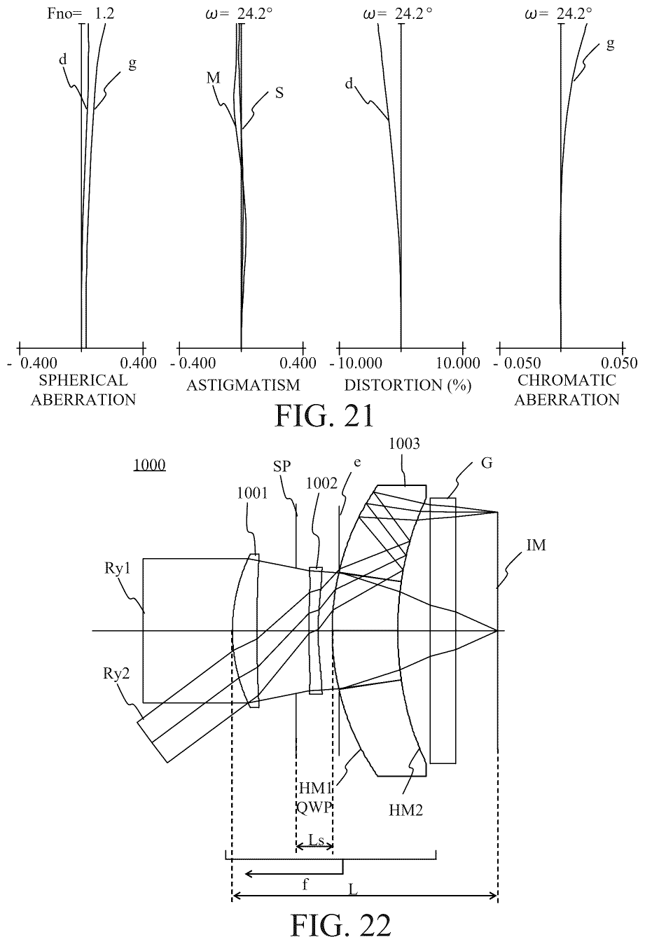

FIG. 21 is an aberration diagram of the optical system 900 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 900 is used as a projection optical system, the enlargement side is a projection side, and the reduction side is a light source panel side. In a case where the optical system 900 is used as an imaging optical system, the enlargement side is an object side, and the reduction side is an image side.

### Example 10

A description will now be given of an optical system 1000 according to Example 10. FIG. 22 is a sectional view of the optical system 1000 in an in-focus state at infinity. The optical system 1000 includes, in order from the enlargement side to the reduction side, a first positive lens (first lens) 1001, a fully opened diaphragm (aperture stop) SP, and a second negative lens (second lens) 1002. The optical system 1000 further includes, in order from the enlargement side to the reduction side, a third lens 1003 having a first transmissive reflective surface HM1 and a second transmissive reflective surface HM2, and a member G such as a glass block such as a prism and a sensor protection glass. The third lens 1003 includes a quarter waveplate QWP on the reduction side of the first transmissive reflective surface HM1. The first positive lens 701, the second negative lens 702, and the third lens 703 constitute a focusing unit f. Focusing is performed by integrally moving each lens of the focusing unit f in the optical axis direction. Ry1 is an on-axis light ray, and Ry2 is the most off-axis light ray. The optical system 1000 is configured to guide the on-axis light ray Ry1 to an image plane IM. e is a flare cut diaphragm configured to cut unnecessary light.

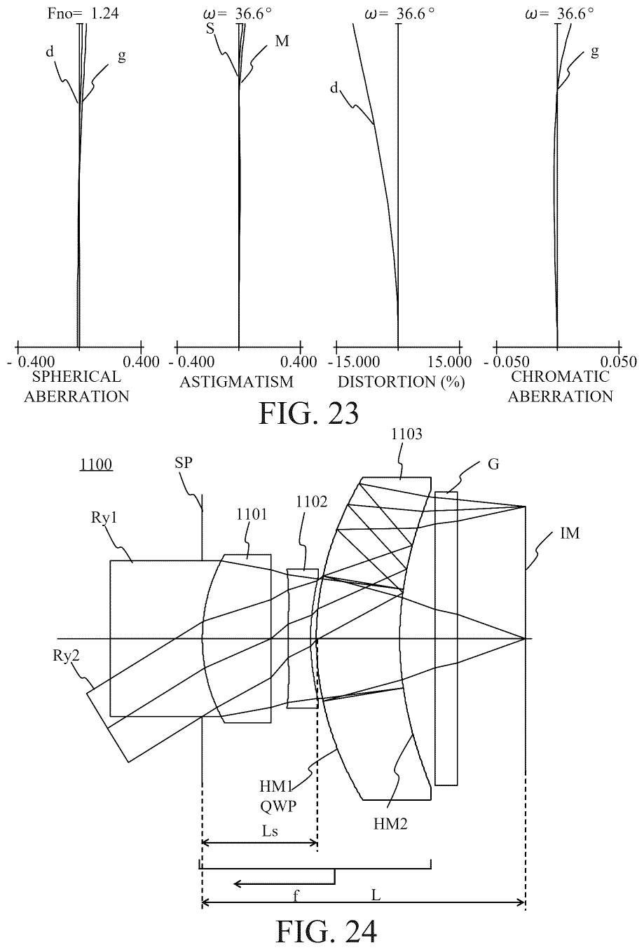

FIG. 23 is an aberration diagram of the optical system 1000 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 1000 is used as a projection optical system, the enlargement side is a projection side, and the reduction side is a light source panel side. In a case where the optical system 1000 is used as an imaging optical system, the enlargement side is an object side, and the reduction side is an image side.

### Example 11

A description will now be given of an optical system 1100 according to Example 11. FIG. 24 is a sectional view of the optical system 1100 in an in-focus state at infinity. The optical system 1100 includes, in order from the enlargement side to the reduction side, a fully opened diaphragm (aperture stop) SP, a first positive lens (first lens) 1101, and a second negative lens (second lens) 1102. The optical system 1100 further includes, in order from the enlargement side to the reduction side, a third lens 1103 having a first transmissive reflective surface HM1 and a second transmissive reflective surface HM2, and a member G such as a glass block such as a prism and a sensor protection glass. The third lens 1103 includes a quarter waveplate QWP on the reduction side of the first transmissive reflective surface HM1. The first positive lens 1101, the second negative lens 1102, and the third lens 1103 constitute a focusing unit f. Focusing is performed by integrally moving each lens of the focusing unit f in the optical axis direction. Ry1 is an on-axis light ray, and Ry2 is the most off-axis light ray. The optical system 1100 is configured to guide the on-axis light ray Ry1 to the image plane IM.

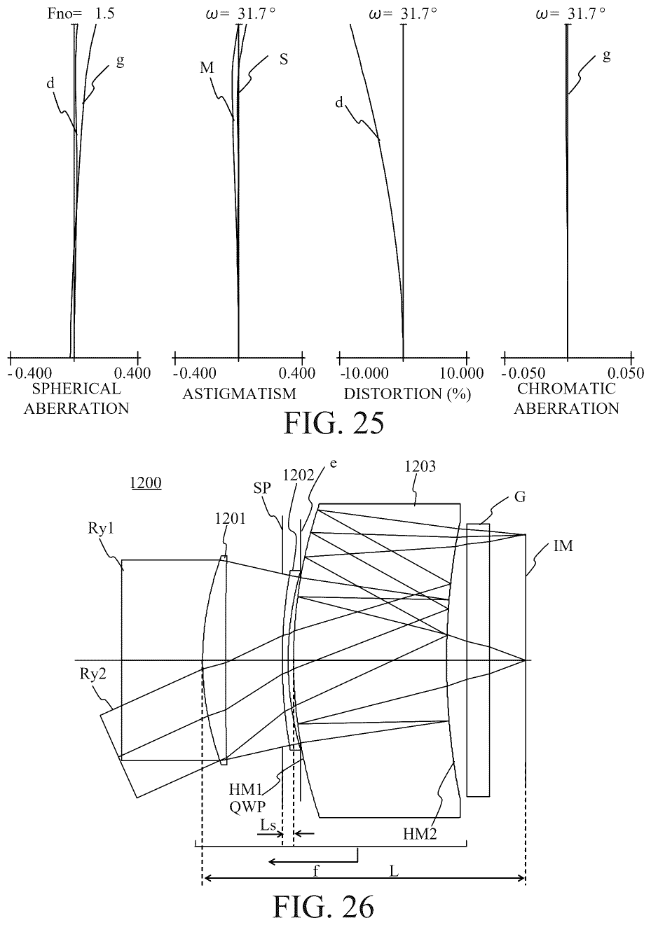

FIG. 25 is an aberration diagram of the optical system 1100 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 1100 is used as a projection optical system, the enlargement side is a projection side, and the reduction side is a light source panel side. In a case where the optical system 1100 is used as an imaging optical system, the enlargement side is an object side, and the reduction side is an image side.

### Example 12

A description will now be given of an optical system 1200 according to Example 12. FIG. 26 is a sectional view of the optical system 1200 in an in-focus state at infinity. The optical system 1200 includes, in order from the enlargement side to the reduction side, a first positive lens (first lens) 1201, a fully opened diaphragm (aperture stop) SP, and a second negative lens (second lens) 1202. The optical system 1200 further includes, in order from the enlargement side to the reduction side, a third lens 1203 having a first transmissive reflective surface HM1 and a second transmissive reflective surface HM2, and a member G such as a glass block such as a prism and a sensor protective glass. The third lens 1203 includes a quarter waveplate QWP on the reduction side of the first transmissive reflective surface HM1. The first positive lens 1201, the second negative lens 1202, and the third lens 1203 constitute a focusing unit f. Focusing is performed by integrally moving each lens of the focusing unit f in the optical axis direction. Ry1 is an on-axis light ray, and Ry2 is the most off-axis light ray. The optical system 1200 is configured to guide the on-axis light ray Ry1 to the image plane IM. e is a flare cut diaphragm configured to cut unnecessary light.

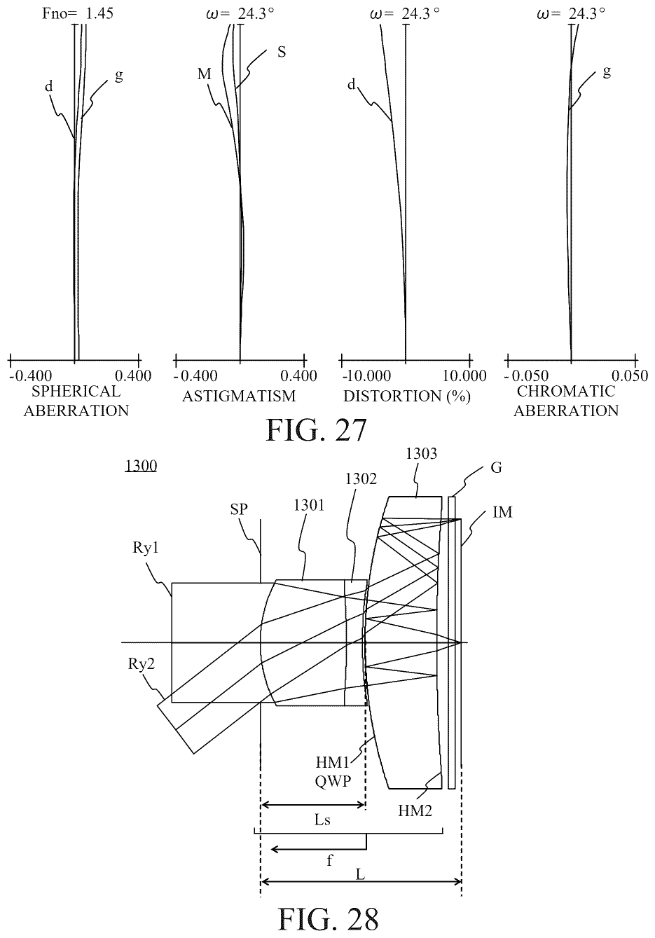

FIG. 27 is an aberration diagram of the optical system 1200 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 1200 is used as a projection optical system, the enlargement side is a projection side, and the reduction side is a light source panel side. In a case where the optical system 1200 is used as an imaging optical system, the enlargement side is an object side, and the reduction side is an image side.

### Example 13

A description will now be given of an optical system 1300 according to Example 13. FIG. 28 is a sectional view of the optical system 1300 in an in-focus state at infinity. The optical system 1300 includes, in order from the enlargement side to the reduction side, a fully opened diaphragm (aperture stop) SP, a cemented lens formed by cementing a first positive lens (first lens) 1301 and a second negative lens (second lens) 1302. The optical system 1300 further includes, in order from the enlargement side to the reduction side, a third lens 1303 having a first transmissive reflective surface HM1 and a second transmissive reflective surface HM2, and a member G such as a glass block such as a prism and a sensor protective glass. The third lens 1303 includes a quarter waveplate QWP on the reduction side of the first transmissive reflective surface HM1. The first positive lens 1301, the second negative lens 1302, and the third lens 1303 constitute a focusing unit f. Focusing is performed by integrally moving each lens that forms the focusing unit f in the optical axis direction. Ry1 is an on-axis light ray, and Ry2 is the most off-axis light ray. The optical system 1300 is configured to guide the on-axis light ray Ry1 to the image plane IM.

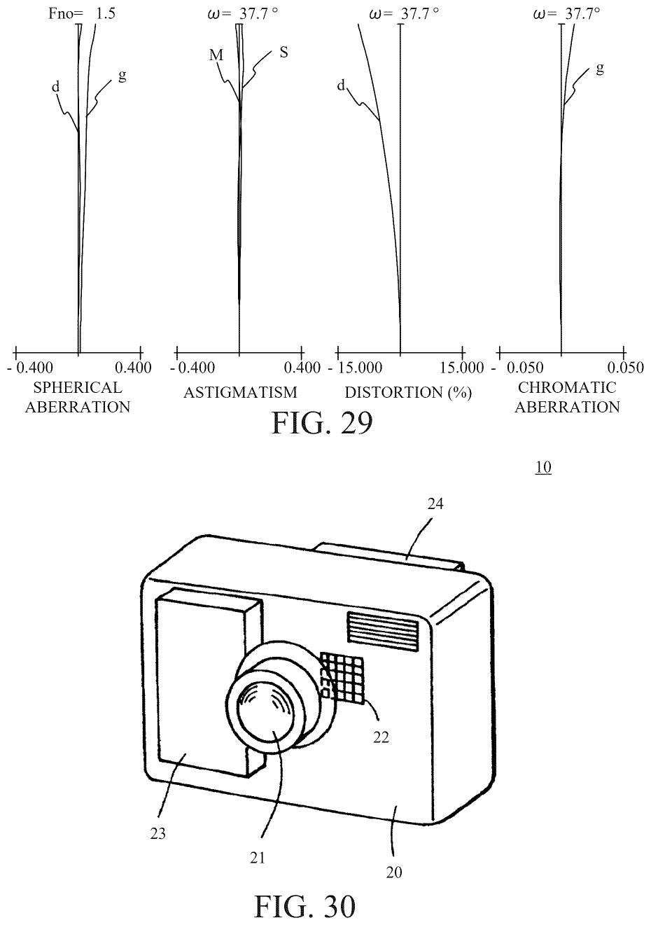

FIG. 29 is an aberration diagram of the optical system 1300 in an in-focus state at infinity. In a spherical aberration diagram, Fno represents an F-number. The spherical aberration diagram illustrates spherical aberration amounts for the d-line and the g-line. In an astigmatism diagram, S illustrates an astigmatism amount on a sagittal image plane, and M illustrates an astigmatism amount on a meridional image plane. A distortion diagram illustrates a distortion amount for the d-line. A chromatic aberration diagram illustrates a chromatic aberration amount for the g-line. ω is a half angle of view (degrees).

In a case where the optical system 1300 is used as a projection optical system, the enlargement side is a projection side, and the reduction side is a light source panel side. In a case where the optical system 1300 is used as an imaging optical system, the enlargement side is an object side, and the reduction side is an image side.

A description will now be given of numerical examples 1 to 13 corresponding to Examples 1 to 13, respectively. In surface data of each numerical example, r represents a radius of curvature of each optical surface, and d (mm) represents an on-axis distance (distance on the optical axis) between m-th and (m+1)-th surfaces, where m is a surface number counted from the light incident side. nd represents a refractive index of each optical element for the d-line, and vd represents the Abbe number of the optical element based on the d-line. The Abbe number vd of a certain material is expressed as follows:

vd=(Nd−1)/(NF−NC)

where Nd, NF, and NC are refractive indices for the d-line, F-line (486.1 nm), and C-line (656.3 nm) in the Fraunhofer line.

In each numerical example, d, focal length (mm), F-number, and half angle of view (degrees) are all values in a case where the optical system according to each example is in focus on an object at infinity. “Back focus” is a distance on the optical axis from the final lens surface (a lens surface closest to the reduction side) to the paraxial image plane, expressed in an air equivalent length. An “overall lens length” is a length on the optical axis from the foremost lens surface (a lens surface closest to the enlargement side) of the optical system to the final surface plus the back focus in an air equivalent length. A “lens unit” includes one or more lenses.

In a case where an optical surface is aspheric, an asterisk “*” is added to the right of the surface number. The aspheric shape is expressed by the following formula:

$$X = ( {h}^{2} / R ) / [ 1 + {\{ 1 - ( 1 + K ) {( h / R )}^{2} \}}^{1 / 2} ] + A 4 \times {h}^{4} + A 6 \times {h}^{6} + A 8 \times {h}^{8} + A 10 \times {h}^{10}$$

where X is a displacement amount from a surface vertex in the optical axis direction, h is a height from the optical axis in a direction perpendicular to the optical axis, R is a paraxial radius of curvature, K is a conic constant, and A4, A6, A8, and A10 are aspheric coefficients of each order.

“e±XX” in each aspheric coefficient means “×10^{±XX}.”

An effective diameter is described for the first transmissive reflective surface and the second transmissive reflective surface. These transmissive reflective surfaces act on a light beam multiple times, but the largest diameter among these effective diameters is described.

### Numerical Example 1

UNIT: mm
SURFACE DATA

| Surface | | | | | Effective |
|---|---|---|---|---|---|
| No. | r | d | nd | νd | Diameter |
| 1 (SP) | ∞ | 0.50 | | | 1.05 |
| 2* | 4.813 | 0.62 | 1.53160 | 55.8 | 1.74 |
| 3* | 7.689 | 0.33 | | | 2.01 |
| 4* | 5.105 | 0.50 | 1.63550 | 23.9 | 2.17 |
| 5* | 3.437 | 0.18 | | | 2.72 |
| 6* | 6.082 | 2.12 | 1.53160 | 55.8 | 7.30 |
| 7* | 5.328 | −2.12 | | | 6.40 |
| 8* | 6.082 | 2.12 | | | 7.30 |
| 9* | 5.328 | 1.86 | | | 6.40 |
| 10 | ∞ | 3.00 | 1.51633 | 64.1 | 6.32 |
| 11 | ∞ | 1.00 | | | 6.49 |
| Image Plane | ∞ | | | | |

ASPHERIC DATA
2nd Surface
K = 0.00000e+00 A4 = 1.59298e−03 A6 = 1.44166e−02
3rd Surface
K = 0.00000e+00 A4 = −7.33771e−02 A6 = 2.56412e−02
4th Surface
K = 0.00000e+00 A4 = −1.54702e−01 A6 = −9.51329e−04
5th Surface
K = 0.00000e+00 A4 = −1.06994e−01 A6 = 1.54292e−02
A8 = −1.41224e−03
6th Surface
K = 0.00000e+00 A4 = −1.04799e−03 A6 = 4.63155e−05
A8 = −3.25879e−06 A10 = 8.39518e−08
7th Surface
K = 0.00000e+00 A4 = −7.31119e−03 A6 = 1.14696e−03
A8 = −9.45610e−05 A10 = 3.25001e−06
8th Surface
K = 0.00000e+00 A4 = −1.04799e−03 A6 = 4.63155e−05
A8 = −3.25879e−06 A10 = 8.39518e−08
9th Surface
K = 0.00000e+00 A4 = −7.31119e−03 A6 = 1.14696e−03
A8 = −9.45610e−05 A10 = 3.25001e−06

VARIOUS DATA

| | |
|---|---|
| ZOOM RATIO | 1.00 |
| Focal Length | 5.25 |
| Fno | 5.00 |
| Half Angle of View (°) | 29.75 |
| Image Height | 3.00 |
| Overall Lens Length | 9.09 |
| BF | 4.84 |

SINGLE LENS DATA

| Lens | Starting Surface | Focal Length |
|---|---|---|
| 1 | 1 | 22.52 |
| 2 | 4 | −18.74 |
| 3 | 6 | −3389.19 |
| 4 | 7 | −3389.19 |
| 5 | 8 | −3389.19 |
| 6 | 10 | 0.00 |

UNIT: mm
SURFACE DATA

| Surface | | | | | Effective |
|---|---|---|---|---|---|
| No. | r | d | nd | νd | Diameter |
| 1 (SP) | ∞ | 0.50 | | | 1.09 |
| 2* | 4.348 | 0.89 | 1.53160 | 55.8 | 1.93 |
| 3* | 12.536 | 1.57 | | | 2.40 |
| 4* | 30.895 | 1.00 | 1.63550 | 23.9 | 3.98 |
| 5* | 7.360 | 0.10 | | | 5.01 |
| 6* | 11.996 | 3.40 | 1.53160 | 55.8 | 12.77 |
| 7* | 13.360 | −3.40 | | | 13.14 |
| 8* | 11.996 | 3.40 | | | 12.77 |
| 9* | 13.360 | 1.54 | | | 13.14 |
| 10 | ∞ | 3.00 | 1.51633 | 64.1 | 13.12 |
| 11 | ∞ | 1.00 | | | 13.09 |
| Image Plane | ∞ | | | | |

ASPHERIC DATA
2nd Surface
K = 0.00000e+00 A4 = 1.05851e−03 A6 = 3.05162e−04
3rd Surface
K = 0.00000e+00 A4 = −2.82512e−04 A6 = 5.82073e−04
4th Surface
K = 0.00000e+00 A4 = −8.97402e−03 A6 = 3.30996e−04
5th Surface
K = 0.00000e+00 A4 = −6.42629e−03 A6 = 5.18231e−04
A8 = −7.44003e−06
6th Surface
K = 0.00000e+00 A4 = −9.75536e−05 A6 = −1.78730e−06
A8 = −7.77142e−09 A10 = −2.54424e−10
7th Surface
K = 0.00000e+00 A4 = −4.48515e−04 A6 = −5.24101e−06
A8 = 2.17552e−08
8th Surface
K = 0.00000e+00 A4 = −9.75536e−05 A6 = −1.78730e−06
A8 = −7.77142e−09 A10 = −2.54424e−10
9th Surface
K = 0.00000e+00 A4 = −4.48515e−04 A6 = −5.24101e−06
A8 = 2.17552e−08

VARIOUS DATA

| | |
|---|---|
| ZOOM RATIO | 1.00 |
| Focal Length | 9.79 |
| Fno | 9.00 |
| Half Angle of View (°) | 33.22 |
| Image Height | 6.41 |
| Overall Lens Length | 11.98 |
| BF | 4.52 |

SINGLE LENS DATA

| Lens | Starting Surface | Focal Length |
|---|---|---|
| 1 | 1 | 12.07 |
| 2 | 4 | −15.46 |
| 3 | 6 | 118.51 |
| 4 | 7 | 118.51 |
| 5 | 8 | 118.51 |
| 6 | 10 | 0.00 |

### Numerical Example 3

UNIT: mm
SURFACE DATA

| Surface No. | r | d | nd | νd | Effective Diameter |
|---|---|---|---|---|---|
| 1* | 91.638 | 1.00 | 1.49700 | 81.6 | 43.80 |
| 2* | 9.699 | 13.04 | | | 19.40 |
| 3* | 34.045 | 1.75 | 1.82165 | 24.0 | 12.74 |
| 4 | −519.385 | 2.62 | | | 11.61 |
| 5 (SP) | ∞ | 0.00 | | | 11.27 |
| 6* | 21.586 | 2.93 | 1.49700 | 81.6 | 11.32 |
| 7 | −22.265 | 0.30 | | | 11.07 |
| 8* | 79.778 | 1.54 | 2.00178 | 19.3 | 10.47 |
| 9* | 22.876 | 0.12 | | | 10.56 |
| 10* | 29.334 | 9.70 | 1.49700 | 81.6 | 47.99 |
| 11* | 28.454 | −9.70 | | | 45.39 |
| 12* | 29.334 | 9.70 | | | 47.99 |
| 13* | 28.454 | 9.55 | | | 45.39 |
| 14 | ∞ | 4.00 | 1.51633 | 64.1 | 45.11 |
| 15 | ∞ | 1.77 | | | 44.38 |
| Image Plane | ∞ | | | | |

ASPHERIC DATA
1st Surface
K = 0.00000e+00 A4 = 1.06298e−05 A6 = −2.53750e−08
A8 = 3.17698e−11 A10 = −1.72216e−14
2nd Surface
K = 0.00000e+00 A4 = 1.57119e−07 A6 = 9.83500e−08
A8 = −3.67081e−10 A10 = −2.17601e−12
3rd Surface
K = 0.00000e+00 A4 = −2.06445e−05 A6 = 2.51199e−07
A8 = 1.26787e−09
6th Surface
K = 0.00000e+00 A4 = 1.45297e−04 A6 = −4.10421e−08
A8 = −3.05902e−08
8th Surface
K = 0.00000e+00 A4 = −2.22953e−04 A6 = 1.86379e−06
A8 = 2.28627e−08
9th Surface
K = 0.00000e+00 A4 = −1.51360e−04 A6 = 2.73312e−06
A8 = 5.62372e−09
10th Surface
K = 0.00000e+00 A4 = −1.94840e−06 A6 = 8.11131e−10
A8 = −7.48915e−12 A10 = −1.59045e−15
11th Surface
K = 0.00000e+00 A4 = −8.28622e−06 A6 = 3.97937e−08
A8 = −8.50100e−11
12th Surface
K = 0.00000e+00 A4 = −1.94840e−06 A6 = 8.11131e−10
A8 = −7.48915e−12 A10 = −1.59045e−15
13th Surface
K = 0.00000e+00 A4 = −8.28622e−06 A6 = 3.97937e−08
A8 = −8.50100e−11

VARIOUS DATA

| | |
|---|---|
| ZOOM RATIO | 1.00 |
| Focal Length | 13.43 |
| Fno | 2.00 |
| Half Angle of View (°) | 58.16 |
| Image Height | 21.63 |
| Overall Lens Length | 46.95 |
| BF | 13.95 |

SINGLE LENS DATA

| Lens | Starting Surface | Focal Length |
|---|---|---|
| 1 | 1 | −21.91 |
| 2 | 3 | 38.94 |
| 3 | 6 | 22.55 |
| 4 | 8 | −32.46 |
| 5 | 10 | 717.38 |
| 6 | 11 | 717.38 |
| 7 | 12 | 717.38 |
| 8 | 14 | 0.00 |

### Numerical Example 4

UNIT: mm
SURFACE DATA

| Surface No. | r | d | nd | νd | Effective Diameter |
|---|---|---|---|---|---|
| 1* | 26.347 | 1.00 | 1.49700 | 81.6 | 27.79 |
| 2* | 11.296 | 10.59 | | | 20.58 |
| 3* | 58.068 | 3.50 | 1.85478 | 24.8 | 13.50 |
| 4 | 392.135 | 3.07 | | | 13.78 |
| 5 (SP) | ∞ | 0.00 | | | 14.38 |
| 6* | 24.890 | 4.16 | 1.49700 | 81.6 | 14.64 |
| 7 | −27.623 | 0.81 | | | 14.34 |
| 8* | 34.547 | 2.26 | 2.00069 | 25.5 | 13.17 |
| 9* | 17.639 | 0.35 | | | 12.26 |
| 10* | 27.463 | 8.55 | 1.49700 | 81.6 | 38.56 |
| 11* | 28.917 | −8.55 | | | 38.46 |
| 12* | 27.463 | 8.55 | | | 38.56 |
| 13* | 28.917 | 4.71 | | | 38.46 |
| 14 | ∞ | 4.00 | 1.51633 | 64.1 | 38.33 |
| 15 | ∞ | 6.87 | | | 37.98 |
| Image Plane | ∞ | | | | |

ASPHERIC DATA
1st Surface
K = 0.00000e+00 A4 = 2.82644e−05 A6 = −1.30278e−07
A8 = 9.27118e−10A10 = −1.95190e−12
2nd Surface
K = 0.00000e+00 A4 = 1.55124e−05 A6 = 5.25719e−09
A8 = −1.57147e−09 A10 = 1.85514e−11
3rd Surface
K = 0.00000e+00 A4 = −2.85144e−05 A6 = 5.63775e−08
A8 = −8.46267e−11
6th Surface
K = 0.00000e+00 A4 = 9.82112e−05 A6 = −2.85734e−07
A8 = 1.89640e−09
8th Surface
K = 0.00000e+00 A4 = −1.87459e−04 A6 = 1.56461e−06
A8 = −8.81601e−09
9th Surface
K = 0.00000e+00 A4 = −1.91926e−04 A6 = 1.99746e−06
A8 = −7.81297e−09
10th Surface
K = 0.00000e+00 A4 = −3.15616e−06 A6 = −7.51703e−09
A8 = −3.55206e−12 A10 = −3.61310e−14
11th Surface
K = 0.00000e+00 A4 = −1.45407e−05 A6 = −1.73107e−08
A8 = −3.99964e−11
12th Surface
K = 0.00000e+00 A4 = −3.15616e−06 A6 = −7.51703e−09
A8 = −3.55206e−12 A10 = −3.67627e−14
13th Surface
K = 0.00000e+00 A4 = −1.45407e−05 A6 = −1.73107e−08
A8 = −3.99964e−11

VARIOUS DATA

| | |
|---|---|
| ZOOM RATIO | 1.00 |
| Focal Length | 16.00 |
| Fno | 1.50 |
| Half Angle of View (°) | 49.16 |
| Image Height | 18.51 |
| Overall Lens Length | 48.51 |
| BF | 14.22 |

SINGLE LENS DATA

| Lens | Starting Surface | Focal Length |
|---|---|---|
| 1 | 1 | −40.68 |
| 2 | 3 | 79.36 |
| 3 | 6 | 27.06 |
| 4 | 8 | −38.60 |
| 5 | 10 | 372.29 |
| 6 | 11 | 372.29 |
| 7 | 12 | 372.29 |
| 8 | 14 | 0.00 |

### Numerical Example 5

UNIT: mm
SURFACE DATA

| Surface No. | r | d | nd | νd | Effective Diameter |
|---|---|---|---|---|---|
| 1 | 33.575 | 1.00 | 1.49700 | 81.6 | 25.47 |
| 2 | 14.325 | 7.68 | | | 20.71 |
| 3 | 38.285 | 3.72 | 1.85478 | 24.8 | 15.30 |
| 4 | 69.660 | 3.51 | | | 15.24 |
| 5 (SP) | ∞ | 0.00 | | | 15.72 |
| 6* | 19.477 | 4.15 | 1.49700 | 81.6 | 16.01 |
| 7 | −59.060 | 0.10 | | | 15.58 |
| 8* | 41.854 | 1.83 | 2.00069 | 25.5 | 15.03 |
| 9* | 21.273 | 0.82 | | | 14.17 |
| 10* | 35.102 | 10.91 | 1.49700 | 81.6 | 41.49 |
| 11* | 41.256 | −10.91 | | | 38.61 |
| 12* | 35.102 | 10.91 | | | 41.49 |
| 13* | 41.256 | 5.29 | | | 38.61 |
| 14 | ∞ | 4.00 | 1.51633 | 64.1 | 38.46 |
| 15 | ∞ | 6.80 | | | 38.08 |
| Image Plane | ∞ | | | | |

ASPHERIC DATA
6th Surface
K = 0.00000e+00 A4 = 3.57108e−05 A6 = −1.39068e−07
A8 = 1.24007e−09
8th Surface
K = 0.00000e+00 A4 = −1.21991e−04 A6 = 1.26867e−06
A8 = −4.82759e−09
9th Surface
K = 0.00000e+00 A4 = −1.19382e−04 A6 = 1.37944e−06
A8 = −3.61115e−09
10th Surface
K = 0.00000e+00 A4 = −1.00209e−06 A6 = −1.74986e−09
A8 = 2.28712e−12 A10 = −8.13336e−15
11th Surface
K = 0.00000e+00 A4 = −3.29705e−06 A6 = 9.82698e−09
A8 = −2.96715e−11
12th Surface
K = 0.00000e+00 A4 = −1.00209e−06 A6 = −1.74986e−09
A8 = 2.28712e−12 A10 = −8.76500e−15
13th Surface
K = 0.00000e+00 A4 = −3.29705e−06 A6 = 9.82698e−09
A8 = −2.96715e−11

VARIOUS DATA

| | |
|---|---|
| ZOOM RATIO | 1.00 |
| Focal Length | 20.00 |
| Fno | 1.50 |
| Half Angle of View (°) | 42.78 |
| Image Height | 18.51 |
| Overall Lens Length | 48.45 |
| BF | 14.73 |

SINGLE LENS DATA

| Lens | Starting Surface | Focal Length |
|---|---|---|
| 1 | 1 | −51.15 |
| 2 | 3 | 94.29 |
| 4 | 8 | −45.25 |
| 5 | 10 | 298.04 |
| 6 | 11 | 298.04 |
| 7 | 12 | 298.04 |
| 8 | 14 | 0.00 |

### Numerical Example 6

UNIT: mm
SURFACE DATA

| Surface No. | r | d | nd | νd | Effective Diameter |
|---|---|---|---|---|---|
| 1 | 19.037 | 1.00 | 1.49700 | 81.6 | 23.92 |
| 2 | 14.325 | 5.74 | | | 21.30 |
| 3 | 49.724 | 4.28 | 1.85478 | 24.8 | 19.48 |
| 4 | 62.429 | 3.89 | | | 19.30 |
| 5 (SP) | ∞ | 0.00 | | | 19.90 |
| 6 | 23.387 | 5.34 | 1.49700 | 81.6 | 20.37 |
| 7 | −96.813 | 0.10 | | | 19.83 |
| 8* | 26.485 | 1.98 | 2.00069 | 25.5 | 18.94 |
| 9* | 17.959 | 0.92 | | | 17.69 |
| 10* | 37.252 | 10.83 | 1.49700 | 81.6 | 43.09 |
| 11* | 46.119 | −10.83 | | | 40.25 |
| 12* | 37.252 | 10.83 | | | 43.09 |
| 13* | 46.119 | 4.92 | | | 40.25 |
| 14 | ∞ | 4.00 | 1.51633 | 64.1 | 39.96 |
| 15 | ∞ | 6.71 | | | 39.18 |
| Image Plane | ∞ | | | | |

ASPHERIC DATA
6th Surface
K = 0.00000e+00 A4 = 1.55070e−05 A6 = −1.70885e−07
A8 = 1.07509e−09
8th Surface
K = 0.00000e+00 A4 = −1.10778e−04 A6 = 9.34434e−07
A8 = −2.97603e−09
9th Surface
K = 0.00000e+00 A4 = −1.33133e−04 A6 = 9.89656e−07
A8 = −2.80838e−09
10th Surface
K = 0.00000e+00 A4 = −8.91400e−07 A6 = −9.69094e−10
A8 = 1.07904e−12 A10 = −5.10341e−15
11th Surface
K = 0.00000e+00 A4 = −2.87123e−06 A6 = 1.10285e−08
A8 = −3.60712e−11
12th Surface
K = 0.00000e+00 A4 = −8.91400e−07 A6 = −9.69094e−10
A8 = 1.07904e−12 A10 = −5.73505e−15
13th Surface
K = 0.00000e+00 A4 = −2.87123e−06 A6 = 1.10285e−08
A8 = −3.60712e−11

VARIOUS DATA

| | |
|---|---|
| ZOOM RATIO | 1.00 |
| Focal Length | 24.00 |
| Fno | 1.24 |
| Half Angle of View (°) | 37.64 |
| Image Height | 18.51 |
| Overall Lens Length | 48.35 |
| BF | 14.27 |

SINGLE LENS DATA

| Lens | Starting Surface | Focal Length |
|---|---|---|
| 1 | 1 | −125.27 |
| 2 | 3 | 247.42 |
| 3 | 6 | 38.47 |
| 4 | 8 | −63.07 |
| 5 | 10 | 277.38 |
| 6 | 11 | 277.38 |
| 7 | 12 | 277.38 |
| 8 | 14 | 0.00 |

### Numerical Example 7

UNIT: mm
SURFACE DATA

| Surface No. | r | d | nd | νd | Effective Diameter |
|---|---|---|---|---|---|
| 1 (SP) | ∞ | 0.00 | | | 22.10 |
| 2* | 25.408 | 3.35 | 1.49700 | 81.6 | 22.10 |
| 3 | 101.284 | 7.79 | | | 21.66 |
| 4* | 87.435 | 1.73 | 2.00069 | 25.5 | 19.90 |
| 5* | 49.167 | 0.10 | | | 21.36 |
| 6* | 40.361 | 10.76 | 1.49700 | 81.6 | 46.62 |
| 7* | 53.229 | −10.76 | | | 41.57 |
| 8* | 40.361 | 10.76 | | | 46.62 |
| 9* | 53.229 | 5.63 | | | 41.57 |
| 10 | ∞ | 4.00 | 1.51633 | 64.1 | 41.15 |
| 11 | ∞ | 6.66 | | | 40.09 |
| Image Plane | ∞ | | | | |

ASPHERIC DATA
2nd Surface
K = 0.00000e+00 A4 = 1.09150e−06 A6 = 1.46734e−08
A8 = −3.35318e−11
4th Surface
K = 0.00000e+00 A4 = −4.05227e−05 A6 = −5.52984e−08
A8 = 3.51679e−10
5th Surface
K = 0.00000e+00 A4 = −3.51461e−05 A6 = −5.98017e−08
A8 = 3.57095e−10
6th Surface
K = 0.00000e+00 A4 = −9.34775e−07 A6 = 1.45594e−09
A8 = 2.28776e−13 A10 = 5.45402e−16
7th Surface
K = 0.00000e+00 A4 = −4.15347e−06 A6 = 2.14400e−08
A8 = −1.60773e−11
8th Surface
K = 0.00000e+00 A4 = −9.34775e−07 A6 = 1.45594e−09
A8 = 2.28776e−13 A10 = −8.62438e−17
9th Surface
K = 0.00000e+00 A4 = −4.15347e−06 A6 = 2.14400e−08
A8 = −1.60773e−11

VARIOUS DATA

| | |
|---|---|
| ZOOM RATIO | 1.00 |
| Focal Length | 27.51 |
| Fno | 1.25 |
| Half Angle of View (°) | 33.93 |
| Image Height | 18.51 |
| Overall Lens Length | 38.66 |
| BF | 14.93 |

SINGLE LENS DATA

| Lens | Starting Surface | Focal Length |
|---|---|---|
| 1 | 1 | 67.26 |
| 2 | 4 | −114.85 |
| 3 | 6 | 262.94 |
| 4 | 7 | 262.94 |
| 5 | 8 | 262.94 |
| 6 | 10 | 0.00 |

### Numerical Example 8

UNIT: mm
SURFACE DATA

| Surface No. | r | d | nd | νd | Effective Diameter |
|---|---|---|---|---|---|
| 1* | 43.704 | 4.51 | 1.49700 | 81.6 | 33.98 |
| 2 | −395.892 | 8.81 | | | 33.75 |
| 3 (SP) | ∞ | 0.00 | | | 30.60 |
| 4* | 55.166 | 6.84 | 1.53160 | 55.8 | 29.60 |
| 5 | −54.815 | 0.10 | | | 28.38 |
| 6* | −78.721 | 1.27 | 1.88202 | 37.2 | 27.67 |
| 7* | 65.588 | 2.95 | | | 26.00 |
| 8* | 59.491 | 11.90 | 1.49700 | 81.6 | 46.09 |
| 9* | 116.270 | −11.90 | | | 42.90 |
| 10* | 59.491 | 11.90 | | | 46.09 |
| 11* | 116.270 | 3.23 | | | 42.90 |
| 12 | ∞ | 4.00 | 1.51633 | 64.1 | 42.67 |
| 13 | ∞ | 6.39 | | | 42.07 |
| Image Plane | ∞ | | | | |

ASPHERIC DATA
1st Surface
K = 0.00000e+00 A4 = −4.67704e−06 A6 = −3.08989e−09
A8 = −7.97462e−13
4th Surface
K = 0.00000e+00 A4 = 1.33099e−05 A6 = 2.38224e−08
A8 = 6.32849e−13
6th Surface
K = 0.00000e+00 A4 = −1.53065e−05 A6 = 4.67203e−08
A8 = −4.58239e−11
7th Surface
K = 0.00000e+00 A4 = −5.72119e−06 A6 = 4.92699e−08
A8 = −1.98994e−11
8th Surface
K = 0.00000e+00 A4 = −5.20470e−07 A6 = 6.26754e−10
A8 = 5.98904e−13 A10 = 9.49519e−16
9th Surface
K = 0.00000e+00 A4 = −1.05024e−06 A6 = 4.50479e−09
A8 = 4.98171e−13
10th Surface
K = 0.00000e+00 A4 = −5.20470e−07 A6 = 6.26754e−10
A8 = 5.98904e−13 A10 = 3.17873e−16
11th Surface
K = 0.00000e+00 A4 = −1.05024e−06 A6 = 4.50479e−09
A8 = 4.98171e−13

VARIOUS DATA

| | |
|---|---|
| ZOOM RATIO | 1.00 |
| Focal Length | 35.00 |
| Fno | 1.03 |
| Half Angle of View (°) | 29.93 |
| Image Height | 20.15 |
| Overall Lens Length | 48.64 |
| BF | 12.26 |

SINGLE LENS DATA

| Lens | Starting Surface | Focal Length |
|---|---|---|
| 1 | 1 | 79.46 |
| 2 | 4 | 52.86 |
| 3 | 6 | −40.40 |
| 4 | 8 | 229.17 |
| 5 | 9 | 229.17 |
| 6 | 10 | 229.17 |
| 7 | 12 | 0.00 |

### Numerical Example 9

UNIT: mm SURFACE DATA

| Surface No. | r | d | nd | νd | Effective Diameter |
|---|---|---|---|---|---|
| 1* | 51.457 | 5.51 | 1.49700 | 81.6 | 41.67 |
| 2 | 12231.122 | 19.66 | | | 41.33 |
| 3 (SP) | ∞ | 2.00 | | | 33.19 |
| 4* | −254.989 | 2.79 | 1.72047 | 34.7 | 32.60 |
| 5 | −61.810 | 1.56 | 1.92286 | 20.9 | 32.37 |
| 6* | −167.224 | 9.05 | | | 32.06 |
| 7 | ∞ | −1.05 | | | 28.24 |
| 8* | 96.179 | 17.18 | 1.49700 | 81.6 | 50.71 |
| 9* | 255.697 | −17.18 | | | 46.55 |
| 10* | 96.179 | 17.18 | | | 50.71 |
| 11* | 255.697 | 2.31 | | | 46.55 |
| 12 | ∞ | 4.00 | 1.51633 | 64.1 | 46.27 |
| 13 | ∞ | 5.76 | | | 45.55 |
| Image Plane | ∞ | | | | |

ASPHERIC DATA
1st Surface
K = 0.00000e+00 A4 = −3.48694e−07 A6 = −4.68927e−10
A8 = 2.20233e−13
4th Surface
K = 0.00000e+00 A4 = −8.66760e−07 A6 = −7.63502e−09
A8 = 2.91475e−11
6th Surface
K = 0.00000e+00 A4 = −5.78538e−07 A6 = −7.11577e−09
A8 = 2.63825e−11
8th Surface
K = 0.00000e+00 A4 = 1.84235e−07 A6 = 3.58581e−10
A8 = −4.20769e−13 A10 = 3.13114e−16
9th Surface
K = 0.00000e+00 A4 = 6.79621e−07 A6 = −4.18462e−11
A8 = 5.74465e−13
10th Surface
K = 0.00000e+00 A4 = 1.84235e−07 A6 = 3.58581e−10
A8 = −4.20769e−13 A10 = 3.13114e−16
11th Surface
K = 0.00000e+00 A4 = 6.79621e−07 A6 = −4.18462e−11
A8 = 5.74465e−13

VARIOUS DATA

| | |
|---|---|
| ZOOM RATIO | 1.00 |
| Focal Length | 50.00 |
| Fno | 1.20 |
| Half Angle of View (°) | 23.40 |
| Image Height | 21.63 |
| Overall Lens Length | 67.40 |
| BF | 10.70 |

SINGLE LENS DATA

| Lens | Starting Surface | Focal Length |
|---|---|---|
| 1 | 1 | 103.96 |
| 2 | 4 | 112.56 |
| 3 | 5 | −107.01 |
| 4 | 8 | 299.49 |
| 5 | 9 | 299.49 |
| 6 | 10 | 299.49 |
| 7 | 12 | 0.00 |

### Numerical Example 10

UNIT: mm
SURFACE DATA

| Surface No. | r | d | nd | νd | Effective Diameter |
|---|---|---|---|---|---|
| 1* | 27.471 | 3.84 | 1.49700 | 81.6 | 22.45 |
| 2 | 198.559 | 6.14 | | | 21.94 |
| 3 (SP) | ∞ | 2.01 | | | 19.62 |
| 4* | 61.858 | 1.51 | 2.00069 | 25.5 | 18.76 |
| 5* | 38.811 | 3.30 | | | 18.51 |
| 6 | 00 | −1.10 | | | 19.09 |
| 7* | 39.465 | 10.33 | 1.49700 | 81.6 | 43.56 |
| 8* | 52.135 | −10.33 | | | 39.86 |
| 9* | 39.465 | 10.33 | | | 43.56 |
| 10* | 52.135 | 5.13 | | | 39.86 |
| 11 | ∞ | 4.00 | 1.51633 | 64.1 | 39.60 |
| 12 | ∞ | 6.61 | | | 38.92 |
| Image Plane | ∞ | | | | |

ASPHERIC DATA
1st Surface
K = 0.00000e+00 A4 = 1.68390e−06 A6 = 5.77125e−09
A8 = 1.67027e−12
4th Surface
K = 0.00000e+00 A4 = −8.42958e−05 A6 = 1.49208e−07
A8 = −1.11295e−10
5th Surface
K = 0.00000e+00 A4 = −8.57631e−05 A6 = 1.87591e−07
A8 = −2.50101e−10
7th Surface
K = 0.00000e+00 A4 = −5.17773e−07 A6 = 8.92860e−10
A8 = 1.85693e−14 A10 = 1.16939e−16
8th Surface
K = 0.00000e+00 A4 = −1.86991e−06 A6 = 1.28414e−08
A8 = −1.38616e−11
9th Surface
K = 0.00000e+00 A4 = −5.17773e−07 A6 = 8.92860e−10
A8 = 1.85693e−14 A10 = −5.14706e−16
10th Surface
K = 0.00000e+00 A4 = −1.86991e−06 A6 = 1.28414e−08
A8 = −1.38616e−11

VARIOUS DATA

| | |
|---|---|
| ZOOM RATIO | 1.00 |
| Focal Length | 27.96 |
| Fno | 1.24 |
| Half Angle of View (°) | 33.51 |
| Image Height | 18.51 |
| Overall Lens Length | 40.41 |
| BF | 14.38 |

SINGLE LENS DATA

| Lens | Starting Surface | Focal Length |
|---|---|---|
| 1 | 1 | 63.67 |
| 2 | 4 | −107.62 |
| 3 | 7 | 257.14 |
| 4 | 8 | 257.14 |
| 5 | 9 | 257.14 |
| 6 | 11 | 0.00 |

### Numerical Example 11

UNIT: mm
SURFACE DATA

| Surface No. | r | d | nd | νd | Effective Diameter |
|---|---|---|---|---|---|
| 1 (SP) | ∞ | 0.00 | | | 23.61 |
| 2* | 26.343 | 10.43 | 1.53160 | 55.8 | 23.61 |
| 3* | 674.385 | 2.70 | | | 20.91 |
| 4* | 157.741 | 3.38 | 1.63550 | 23.9 | 19.41 |
| 5* | 32.207 | 0.89 | | | 18.21 |
| 6* | 44.567 | 12.72 | 1.53160 | 55.8 | 47.10 |
| 7* | 50.665 | −12.72 | | | 43.17 |
| 8* | 44.567 | 12.72 | | | 47.10 |
| 9* | 50.665 | 5.42 | | | 43.17 |
| 10 | ∞ | 3.38 | 1.51633 | 64.1 | 42.99 |
| 11 | ∞ | 10.38 | | | 42.59 |
| Image Plane | ∞ | | | | |

ASPHERIC DATA
2nd Surface
K = 0.00000e+00 A4 = 3.26025e−06 A6 = 4.22486e−09
3rd Surface
K = 0.00000e+00 A4 = −2.52001e−06 A6 = −3.34475e−08
4th Surface
K = 0.00000e+00 A4 = −5.28388e−05 A6 = 5.93945e−08
5th Surface
K = 0.00000e+00 A4 = −4.27604e−05 A6 = 9.75926e−08
A8 = 4.84214e−11
6th Surface
K = 0.00000e+00 A4 = −6.02337e−07 A6 = 1.66776e−10
A8 = −1.70184e−13 A10 = −5.24160e−16
7th Surface
K = 0.00000e+00 A4 = −2.96823e−06 A6 = 6.05593e−09
A8 = −8.44780e−12
8th Surface
K = 0.00000e+00 A4 = −6.02337e−07 A6 = 1.66776e−10
A8 = −1.70184e−13 A10 = −5.24160e−16
9th Surface
K = 0.00000e+00 A4 = −2.96823e−06 A6 = 6.05593e−09
A8 = −8.44780e−12

VARIOUS DATA

| | |
|---|---|
| ZOOM RATIO | 1.00 |
| Focal Length | 35.41 |
| Fno | 1.50 |
| Half Angle of View (°) | 29.48 |
| Image Height | 20.02 |
| Overall Lens Length | 48.15 |
| BF | 18.03 |

SINGLE LENS DATA

| Lens | Starting Surface | Focal Length |
|---|---|---|
| 1 | 1 | 51.28 |
| 2 | 4 | −64.35 |
| 3 | 6 | 404.02 |
| 4 | 7 | 404.02 |
| 5 | 8 | 404.02 |
| 6 | 10 | 0.00 |

### Numerical Example 12

UNIT: mm
SURFACE DATA

| Surface No. | r | d | nd | νd | Effective Diameter |
|---|---|---|---|---|---|
| 1* | 50.423 | 3.95 | 1.69680 | 55.5 | 34.48 |
| 2 | 691.944 | 9.87 | | | 34.15 |
| 3 (SP) | ∞ | 0.00 | | | 29.78 |
| 4* | 87.463 | 1.00 | 1.94594 | 18.0 | 29.23 |
| 5 | 55.698 | 2.15 | | | 28.58 |
| 6 | ∞ | −1.20 | | | 28.50 |
| 7* | 83.379 | 26.55 | 1.49700 | 81.6 | 51.88 |
| 8* | 127.619 | −26.55 | | | 45.63 |
| 9* | 83.379 | 26.55 | | | 51.88 |
| 10* | 127.619 | 3.48 | | | 45.63 |
| 11 | ∞ | 4.00 | 1.51633 | 64.1 | 45.38 |
| 12 | ∞ | 6.20 | | | 44.89 |
| Image Plane | ∞ | | | | |

ASPHERIC DATA
1st Surface
K = 0.00000e+00 A4 = −3.97730e−07 A6 = −1.28949e−09
A8 = 1.64575e−12
4th Surface
K = 0.00000e+00 A4 = −2.89622e−07 A6 = 1.37573e−09
A8 = −2.98261e−12
7th Surface
K = 0.00000e+00 A4 = −1.95317e−09 A6 = 8.83267e−11
A8 = −1.08604e−13 A10 = 5.44225e−17
8th Surface
K = 0.00000e+00 A4 = 1.37936e−07 A6 = 1.18914e−10
A8 = 1.72537e−13
9th Surface
K = 0.00000e+00 A4 = −1.95317e−09 A6 = 8.83267e−11
A8 = −1.08604e−13 A10 = 5.44225e−17
10th Surface
K = 0.00000e+00 A4 = 1.37936e−07 A6 = 1.18914e−10
A8 = 1.72537e−13

VARIOUS DATA

| | |
|---|---|
| ZOOM RATIO | 1.00 |
| Focal Length | 50.00 |
| Fno | 1.45 |
| Half Angle of View | 23.40 |
| Image Height | 21.63 |
| Overall Lens Length | 54.64 |
| BF | 12.32 |

SINGLE LENS DATA

| Lens | Starting Surface | Focal Length |
|---|---|---|
| 1 | 1 | 77.85 |
| 2 | 4 | −164.65 |
| 3 | 7 | 403.54 |
| 4 | 8 | 403.54 |
| 5 | 9 | 403.54 |
| 6 | 11 | 0.00 |

### Numerical Example 13

UNIT: mm
SURFACE DATA

| Surface No. | r | d | nd | νd | Effective Diameter |
|---|---|---|---|---|---|
| 1 (SP) | ∞ | 0.00 | | | 18.75 |
| 2* | 20.527 | 13.75 | 1.60562 | 43.7 | 18.75 |
| 3 | −100.754 | 2.55 | 2.00178 | 19.3 | 14.66 |
| 4* | 77.505 | 0.41 | | | 16.90 |
| 5* | 71.203 | 11.45 | 1.51633 | 64.1 | 44.07 |
| 6* | 457.607 | −11.45 | | | 44.00 |
| 7* | 71.203 | 11.45 | | | 44.07 |
| 8* | 457.607 | 1.84 | | | 44.00 |
| 9 | ∞ | 1.00 | 1.51633 | 64.1 | 44.03 |
| 10 | ∞ | 1.00 | | | 44.04 |
| Image Plane | ∞ | | | | |

ASPHERIC DATA
2nd Surface
K = 0.00000e+00 A4 = 2.34346e−06 A6 = 2.26090e−08
4th Surface
K = 0.00000e+00 A4 = 1.76035e−05 A6 = 3.34364e−08
A8 = 4.08744e−10
5th Surface
K = 0.00000e+00 A4 = −5.64718e−07 A6 = 6.77253e−10
A8 = 5.67978e−13 A10 = 2.86767e−16
6th Surface
K = 0.00000e+00 A4 = 1.25166e−06 A6 = 4.37570e−09
A8 = −1.00957e−11
7th Surface
K = 0.00000e+00 A4 = −5.64718e−07 A6 = 6.77253e−10
A8 = 5.67978e−13 A10 = 2.86767e−16
8th Surface
K = 0.00000e+00 A4 = 1.25166e−06 A6 = 4.37570e−09
A8 = −1.00957e−11

VARIOUS DATA

| | |
|---|---|
| ZOOM RATIO | 1.00 |
| Focal Length | 28.13 |
| Fno | 1.50 |
| Half Angle of View (°) | 34.74 |
| Image Height | 19.51 |
| Overall Lens Length | 31.66 |
| BF | 3.50 |

SINGLE LENS DATA

| Lens | Starting Surface | Focal Length |
|---|---|---|
| 1 | 1 | 29.41 |
| 2 | 3 | −43.42 |
| 3 | 5 | 161.68 |
| 4 | 6 | 161.68 |
| 5 | 7 | 161.68 |
| 6 | 9 | 0.00 |

Table 1 summarizes values of inequalities according to each example.

| | | | | | | | | | | | | | | |
|---|---|---|---|---|---|---|---|---|---|---|---|---|---|---|
| INEQUALITY | | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

### Image Pickup Apparatus

Referring to FIG. 30 an image pickup apparatus having the optical system according to any one of the above examples will be described. FIG. 30 is a schematic diagram of a digital camera 10, which is an example image pickup apparatus. Reference numeral 20 denotes a digital camera body, reference numeral 21 denotes an imaging optical system that is one of the optical systems according to the above examples, and reference numeral 22 denotes an image sensor such as a CCD that receives an object image formed by the imaging optical system 21. Reference numeral 23 denotes a recorder configured to record the object image received by the image sensor 22, and reference numeral 24 denotes a viewfinder for observing the object image displayed on a display element (not illustrated). The display element includes a liquid crystal panel or the like, and displays the object image formed on the image sensor 22. Reference numeral 25 denotes a liquid crystal display panel that has the same function as the viewfinder 24.

Thus, applying the optical system according to any one of the above examples to the image pickup apparatus can achieve an image pickup apparatus having a reduced size and high optical performance.

### Projection Apparatus

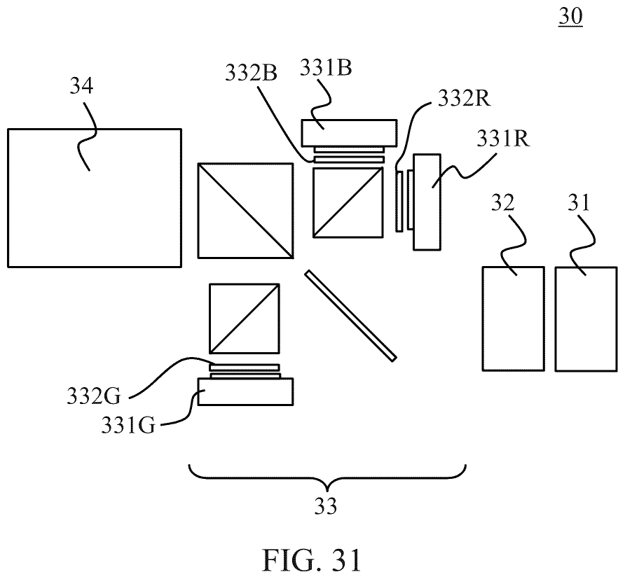

Referring to FIG. 31, a projection apparatus having the optical system according to any one of the above examples will be described. FIG. 31 is a configuration diagram of a projector 30, which is an example projection apparatus. A light-emitting panel such as an LCOS or DMD is used as the light modulation element (display element) of the projector 30. In FIG. 31, reference numeral 31 denotes a light source apparatus, reference numeral 32 denotes an illumination optical system, reference numeral 33 denotes a color separation/combination optical system, and reference numeral 34 denotes a projection optical system which is one of the optical systems according to the above examples. The light source apparatus 31 emits light toward the illumination optical system 32. The illumination optical system 32 illuminates the light from the light source apparatus 31. The color separation/combination optical system 33 performs color separation and color combination for the illumination light from the illumination optical system 32. The projection optical system 34 projects the combined light from the color separation/combination optical system 33. The light emitted by the light emitting panel projects an image on the object side of the projection optical system 34.

In the color separation/combination optical system 33, reference numerals 331R, 331G, and 331B denote light emitting panel units having red, green, and blue light modulation elements (red, green, and blue light-emitting panels or display elements), respectively. Reference numerals 332R, 332G, and 332B denote waveplate units having red, green, and blue waveplates, respectively. The number of light emitting panels is not limited to this example, and the disclosure is applicable to any projector, such as a single panel type or a three-panel type.

Each example can provide an optical system, an image pickup apparatus, and a projection apparatus, each of which can have a reduced size, a large aperture diameter, and high optical performance.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-007715, which was filed on Jan. 23, 2024, and which is hereby incorporated by reference herein in its entirety.

What is claimed is:

1. An optical system comprising, in order from an enlargement side to a reduction side:
a first transmissive reflective surface;
a quarter waveplate; and
a second transmissive reflective surface,
wherein light from the enlargement side transmits through the first transmissive reflective surface and the quarter waveplate in this order, is reflected by the second transmissive reflective surface toward an enlargement side, transmits through the quarter waveplate, is reflected by the first transmissive reflective surface toward the reduction side, and transmits through the quarter waveplate and the second transmissive reflective surface in this order toward the reduction side,
wherein each of the first transmissive reflective surface and the second transmissive reflective surface has a convex surface facing the enlargement side,
wherein the optical system further comprises:
a first lens that has a lens surface different from the first transmissive reflective surface and the second transmissive reflective surface; and
a second lens arranged on the reduction side of the first lens, and
wherein one of the first lens and the second lens has negative refractive power and is disposed adjacent to and on the enlargement side the first transmissive reflective surface.

2. An optical system comprising:
a fully opened diaphragm; and
a first transmissive reflective surface, a quarter waveplate, and a second transmissive reflective surface, which are arranged in this order from an enlargement side to a reduction side,
wherein light from the enlargement side transmits through the first transmissive reflective surface and the quarter waveplate in this order, is reflected by the second transmissive reflective surface to the enlargement side, transmits through the quarter waveplate, is reflected by the first transmissive reflective surface to the reduction side, and transmits through the quarter waveplate and the second transmissive reflective surface in this order toward the reduction side,
wherein each of the first transmissive reflective surface and the second transmissive reflective surface has a convex surface facing the enlargement side, and
wherein the following inequality is satisfied:
$$0. \leq Ls / L \leq 1.$$
where L is a distance on an optical axis from an enlargement-side surface of a lens closest to the enlargement side of the optical system to a panel plane, and Ls is a distance on an optical axis from the fully opened diaphragm to the first transmissive reflective surface.

3. The optical system according to claim 1, wherein at least one of the first lens and the second lens has positive refractive power.

4. The optical system according to claim 1, wherein at least one of the first lens and the second lens has negative refractive power.

5. The optical system according to claim 1, wherein one of the first lens and the second lens has positive refractive power, and
wherein the other of the first lens and the second lens has negative refractive power.

6. The optical system according to claim 1, wherein the first lens and the second lens are disposed on the enlargement side of the first transmissive reflective surface.

7. The optical system according to claim 1, wherein the lens disposed on the enlargement side of one of the first lens and the second lens has a positive refractive power, and
wherein the following inequality is satisfied:
$$0.5 \leq fp / f \leq 10.0$$
where fp is a focal length of the lens having the positive refractive power, and f is a focal length of the optical system.

8. The optical system according to claim 1, wherein the optical system is configured to guide an on-axis light ray to a panel plane.

9. The optical system according to claim 2, wherein the following inequality is satisfied:
$$0.03 \leq D / LD \leq 1.5$$
where D is an aperture diameter of the fully opened diaphragm, and LD is a distance on the optical axis from the fully opened diaphragm to the panel plane.

10. The optical system according to claim 2, wherein the optical system are disposed on the reduction side of the fully opened aperture.

11. The optical system according to claim 1, wherein the following inequality is satisfied:
$$- 2.00 \leq fF / fR \leq 10.00$$
where fR is a focal length in a range between the first transmissive reflective surface and the second transmissive reflective surface, and fF is a focal length in a range on the enlargement side of the first transmissive reflective surface.

12. The optical system according to claim 1, wherein the following inequality is satisfied:
$$0.15 \leq Ld / La \leq 0.80$$
where La is a thickness on an optical axis from an enlargement-side surface of a lens closest to the enlargement side of the optical system to a reduction-side surface of a lens closest to the reduction side of the optical system, and Ld is a distance on the optical axis from the first transmissive reflective surface to the second transmissive reflective surface.

13. The optical system according to claim 1, wherein the following inequality is satisfied:
$$0.5 \leq La / f \leq 3.$$
where La is a thickness on an optical axis from an enlargement-side surface of a lens closest to the enlargement side of the optical system to a reduction-side surface of a lens closest to the reduction side of the optical system, and f is a focal length of the optical system.

14. The optical system according to claim 1, wherein the following inequality is satisfied:
$$0.10 \leq Lh / L \leq 1.$$
where L is a distance on an optical axis from an enlargement-side surface of a lens closest to the enlargement side of the optical system to a panel plane, and Lh is a distance on the optical axis from the first transmissive reflective surface to the panel plane.

15. The optical system according to claim 1, wherein the following inequality is satisfied:
$$0.3 \leq Lh / f \leq 3.$$
where Lh is a distance on an optical axis from the first transmissive reflective surface to a panel plane, and f is a focal length of the optical system.

16. The optical system according to claim 1, wherein a range between the first transmissive reflective surface and the second transmissive reflective surface is filled with a medium other than air, and
wherein the following inequality is satisfied:
$$1. 40 \leq n d \leq 2.30$$
where nd is a refractive index of the medium for d-line.

17. The optical system according to claim 1, wherein the optical system has a negative lens disposed adjacent to and on the enlargement side of the first transmissive reflective surface, and
wherein the following inequality is satisfied:
$$- 10.00 \leq fN / f \leq - 0.50$$
where fN is a focal length of the negative lens.

18. The optical system according to claim 1, wherein the second transmissive reflective surface is disposed on the reduction side of the first transmissive reflective surface, and
wherein the following inequality is satisfied:
$$- 0.5 \leq f / fR \leq 2.00$$
where f is a focal length of the optical system, and fR is a focal length in a range between the first transmissive reflective surface and the second transmissive reflective surface.

19. The optical system according to claim 1, wherein the following inequality is satisfied:
$$0.05 \leq Li / L \leq 1.$$
where Li is a distance on an optical axis from the second transmissive reflective surface to a panel plane, and L is a distance on an optical axis from an enlargement-side surface of a lens closest to the enlargement side of the optical system to the panel plane.

20. The optical system according to claim 1, wherein the second transmissive reflective surface is a reduction-side surface of a lens disposed closest to the enlargement side of the optical system.

21. The optical system according to claim 1, wherein the following inequality is satisfied:
$$- 1. \leq ( R 1 - R 2 ) / ( R 1 + R 2 ) \leq 1.$$
where R1 is a radius of curvature of the first transmissive reflective surface, and R2 is a radius of curvature of the second transmissive reflective surface.

22. The optical system according to claim 1, wherein the following inequality is satisfied:
$$0.10 \leq Ld / f \leq 2.00$$
where Ld is a distance on an optical axis from the first transmissive reflective surface to the second transmissive reflective surface, and f is a focal length of the optical system.

23. The optical system according to claim 1, wherein the following inequality is satisfied:
$$0.1 \leq Oe / Ie \leq 2.00$$
where Oe is an outer diameter of a lens disposed closest to the enlargement side of the optical system, and Ie is an outer diameter of a lens disposed closest to the reduction side of the optical system.

24. The optical system according to claim 1, wherein one of the first transmissive reflective surface and the second transmissive reflective surface is a surface that separates incident light into reflected light and transmitting light according to a polarization state.

25. The optical system according to claim 1, wherein the other of the first transmissive reflective surface and the second transmissive reflective surface is a surface of a half-mirror or a cholesteric liquid crystal.

26. The optical system according to claim 25, wherein the optical system is rotationally symmetric with respect to an optical axis.

27. The optical system according to claim 1, wherein the following inequality is satisfied:
$$0.5 \leq Fno \leq 15.$$
where Fno is an F-number of the optical system.

28. An image pickup apparatus comprising:
an optical system; and
an element configured to receive an image formed by the optical system.

29. A projection apparatus comprising:
an optical system; and
a display element,
wherein the optical system includes, in order from an enlargement side to a reduction side:
a first transmissive reflective surface;
a quarter waveplate; and
a second transmissive reflective surface,
wherein light from the enlargement side transmits through the first transmissive reflective surface and the quarter waveplate in this order, is reflected by the second transmissive reflective surface toward an enlargement side, transmits through the quarter waveplate, is reflected by the first transmissive reflective surface toward the reduction side, and transmits through the quarter waveplate and the second transmissive reflective surface in this order toward the reduction side,
wherein each of the first transmissive reflective surface and the second transmissive reflective surface has a convex surface facing the enlargement side,
wherein the optical system further comprises:
a first lens that has a lens surface different from the first transmissive reflective surface and the second transmissive reflective surface; and
a second lens arranged on the reduction side of the first lens, and
wherein one of the first lens and the second lens has negative refractive power and is disposed adjacent to and on the enlargement side the first transmissive reflective surface.
